(19) United States
(12) Patent Application Publication
(10) Pub. No.: US 2023/0087662 A1
(43) Pub. Date: Mar. 23, 2023

(54) SYSTEMS AND METHODS FOR CALIBRATION

(71) Applicant: Smartex Europe, Unipessoal LDA., Porto (PT)

(72) Inventors: Gilberto MARTINS LOUREIRO, Porto (PT); Antonio ROCHA, Porto (PT); Paulo RIBEIRO, Porto (PT); Ana Catarina VIOLANTE VIEIRA, Porto (PT)

(21) Appl. No.: 17/936,470

(22) Filed: Sep. 29, 2022

Related U.S. Application Data
(63) Continuation of application No. PCT/IB2021/052569, filed on Mar. 29, 2021.

(30) Foreign Application Priority Data
Mar. 30, 2020 (PT) PCT/PT2020/050013

(51) Int. Cl. G01B 11/25; G06T 1/00; G06T 7/70; G06T 7/62; G06T 7/80

(52) U.S. Cl. CPC G01B 11/2504; G06T 1/0007; G06T 7/70; G06T 7/62; G06T 7/80

(57) ABSTRACT

The present disclosure provides systems and methods for calibration. In one example, the method may comprise optical image analysis for calibration. The method may comprise generating an optical projection of one or more calibration features onto a material surface provided in a material fabrication or processing machine, and determining one or more spatial characteristics of the calibration features. The one or more spatial characteristics may comprise a distance, a position, an orientation, an alignment, a size, or a shape of one or more calibration features. The one or more spatial characteristics may be used to adjust at least one of (i) a position or an orientation of an imaging unit relative to the material surface and the material fabrication or processing machine, (ii) an angle or an inclination of the material surface relative to the imaging unit, and (iii) one or more imaging parameters of the imaging unit.

### CROSS-REFERENCE

This application is a Continuation Application of International Application No. PCT/IB2021/052569 filed on Mar. 29, 2021, which claims priority to International Application No. PCT/PT2020/050013 filed on Mar. 30, 2020, all of which are incorporated herein by reference in their entirety for all purposes.

### BACKGROUND

Some materials and products may be produced by high-volume manufacturing processes. Such materials and products may include textiles such as natural or synthetic fabrics, structural materials such as sheet metals, piping, and wood products, paper products and other materials such as ceramics, composites, and plastics.

Manufactured products may be produced via specialized machinery that produce such products on a continuous or batch-wise basis. For example, textiles may be produced on knitting machines that extrude a continuous sheet of knitted fabric. Manufactured products may be produced in a range of dimensions including varying lengths, widths, or thicknesses. Manufacturing equipment and machinery may include process sensing and control equipment.

### SUMMARY

Recognized herein is a need for calibration systems and methods that can be used to calibrate optical detection systems, prior to or as the optical detection systems are monitoring an output from manufacturing equipment. Calibration of the optical detection systems can align the detection systems in a predetermined configuration relative to the manufacturing equipment, such that the detection systems may be capable of detecting subtle or obvious manufacturing defects that may escape human detection. In some cases, defects in a manufactured product, such as needle defects in a textile product, may not be readily apparent to the human eye. In other cases, products may be released from a manufacturing process and moved to subsequent processes at a rate that exceeds the human ability to recognize and remove defective products from the product stream. Optical detection systems may offer more accurate defect detection capabilities over a much longer time period and at much higher rates of detection than humans can operate. Manufacturing systems can be readily modified to include optical detection systems that are operatively coupled to and/or comprise computer systems for defect detection and quality control. In some cases, such detection systems may be capable of isolating defective products from a product stream. In other cases, such detection systems may be capable of recognizing defects arising from malfunctioning manufacturing equipment, thereby allowing stoppage of the defective equipment. Optical detection systems for manufacturing equipment can permit reduced loss from the production of unsellable product, as well as reduced danger from the export of potentially unsound structural materials.

The present disclosure provides calibration systems for calibrating a position and/or an orientation of an optical detection system. Calibration may allow an optical detection system to determine a quality of a material or to detect one or more defects more accurately, more reliably, and more efficiently. Calibration may further improve a quality of a software calibration used to fine tune one or more images acquired and/or processed by an optical detection system. Calibration may also increase an area over which the optical detection system can accurately and/or reliably detect one or more defects. Calibration may also reduce distortions in one or more images acquired and/or processed by the optical detection system. In some cases, calibration may reduce an amount of software calibration required for the optical detection system to reliably detect defects. In other cases, calibration may reduce a number of false positives or false negatives when the optical detection system is used to detect one or more defects.

In an aspect, the present disclosure provides a method for defect detection and quality control. The method may comprise: (a) obtaining one or more images of a material surface that is provided in a material fabrication or processing machine, wherein said material surface comprises one or more calibration features; (b) determining one or more spatial characteristics of said one or more calibration features based at least in part on said one or more images, wherein said one or more spatial characteristics comprise one or more of the following: (i) a distance between said one or more calibration features, (ii) a position, (iii) an orientation, (iv) an alignment, (v) a size or (vi) a shape of said one or more calibration features; and (c) using said one or more spatial characteristics to adjust at least one of (i) a position or an orientation of an imaging unit relative to said material surface or relative to said material fabrication or processing machine, (ii) an angle or an inclination of said material surface relative to said imaging unit, and (iii) one or more imaging parameters of said imaging unit, wherein said one or more imaging parameters comprise an exposure time, a shutter speed, an aperture, a film speed, a field of view, an area of focus, a focus distance, a capture rate, or a capture time associated with said imaging unit.

In some embodiments, the method may comprise generating said one or more calibration features by optically projecting said one or more calibration features onto said material surface.

In some embodiments, the method may further comprise detecting one or more defects in said material surface based on said one or more images. In some embodiments, the method may further comprise determining or monitoring a quality of said material surface based on said one or more images.

In another aspect, the present disclosure provides a method for calibration. The method may comprise (a) generating an optical projection of one or more calibration features onto a material surface that is provided in a material fabrication or processing machine; (b) determining one or more spatial characteristics of the one or more calibration features based at least in part on the optical projection, wherein the one or more spatial characteristics comprise one or more of the following: (i) a distance between the one or more calibration features, (ii) a position, (iii) an orientation, (iv) an alignment, (v) a size or (vi) a shape of the one or more calibration features; and (c) using the one or more spatial characteristics to adjust at least one of (i) a position or an orientation of an imaging unit relative to the material surface or relative to the material fabrication or processing machine, (ii) an angle or an inclination of the material surface relative to the imaging unit, and (iii) one or more imaging parameters of the imaging unit, wherein the one or more imaging parameters comprise an exposure time, a shutter speed, an aperture, a film speed, a field of view, an area of focus, a focus distance, a capture rate, or a capture time associated with the imaging unit.

In some embodiments, the one or more calibration features may comprise one or more zero-dimensional (0-D) features. The one or more zero-dimensional (0-D) features may comprise one or more dots. The one or more dots may comprise one or more laser dots.

In some embodiments, the one or more calibration features may comprise one or more one-dimensional (1-D) features. The one or more one-dimensional (1-D) features may comprise one or more lines. In some embodiments, at least one of the lines may be substantially straight or linear. In some embodiments, at least one of the lines may be substantially non-linear. In some embodiments, at least one of the lines may have a curved portion. In some embodiments, at least one of the lines may be a solid line. In some embodiments, at least one of the lines may be a broken line comprising two or more line segments. In some embodiments, at least two of the lines may be parallel to each other. In some embodiments, at least two of the lines may be non-parallel to each other. In some embodiments, at least two of the lines may be at an oblique angle to each other. In some embodiments, at least two of the lines may intersect with each other. In some embodiments, at least two of the lines may not intersect with each other. In some embodiments, at least two of the lines may be perpendicular to each other. In some embodiments, at least two of the lines may be non-perpendicular to each other. In some embodiments, at least two of the lines may overlap with each other. In some embodiments, at least two of the lines may converge at a point. In some embodiments, at least one of the lines may extend along a vertical axis when projected onto the material surface. In some embodiments, at least one of the lines may extend along a horizontal axis when projected onto the material surface. In some embodiments, at least one of the lines may extend at an angle when projected onto the material surface, wherein the angle is from about zero degrees to about 360 degrees.

In some embodiments, the one or more calibration features may comprise one or more two-dimensional (2D) features. In some embodiments, the one or more two-dimensional (2D) features may comprise one or more shapes. In some embodiments, at least one of the shapes may be a regular shape. In some embodiments, the regular shape may comprise a circle, an ellipse, or a polygon. In some embodiments, the polygon may be an n-sided polygon, wherein n is greater than three. In some embodiments, at least one of the shapes may be an irregular or amorphous shape. In some embodiments, at least two of the shapes may be provided separately without overlapping with each other. In some embodiments, at least two of the shapes may overlap with each other. In some embodiments, at least two of the shapes may lie along a common horizontal axis. In some embodiments, at least two of the shapes may lie along a common vertical axis. In some embodiments, at least two of the shapes may lie along a common axis that extends at an angle from about zero degrees to about 360 degrees.

In some embodiments, the one or more two-dimensional (2D) features may comprise a scannable code. The scannable code may comprise, for example, a Quick Response (QR) code or a barcode. In some embodiments, the one or more two-dimensional (2D) features may comprise a visual or optical pattern. In some embodiments, the visual or optical pattern may comprise a chessboard-like or checkerboard-like pattern to calibrate one or more cameras or imaging units as described elsewhere herein. The chessboard-like or checkerboard-like pattern may comprise a series of contiguous or non-contiguous shapes (e.g., squares or any polygon having three or more sides) with different colors or shades. In some embodiments, the visual or optical pattern may comprise one or more images with high contrast to enable optimization or calibration of one or more light sources, cameras, or imaging units. Such optimization or calibration may comprise, for example, adjusting a focus, an aperture, and/or an exposure time of the one or more cameras or imaging units. In some cases, the optimization or calibration may comprise a calibration of a position and/or orientation of one or more light sources, or an operational parameter of the one or more light sources. The one or more light sources may be used to generate optical projections of one or more calibration features. The one or more light sources may be part of an optical projection unit as described elsewhere herein. The operational parameter of the one or more light sources may comprise, for example, an intensity, a color, a brightness, a temperature, a wavelength, a frequency, a pulse width, a pulse frequency, or any other parameter that controls a transmission of light/electromagnetic waves or a physical characteristic of light/electromagnetic waves.

In some embodiments, the one or more calibration features may comprise one or more three-dimensional (3D) features. In some embodiments, the one or more three-dimensional (3D) features may comprise one or more holographic features. In some embodiments, the one or more calibration features may comprise one or more edge markers. In some embodiments, the one or more edge markers may be projected at or near one or more corners or edges of the material surface. In some embodiments, the one or more calibration features may comprise one or more calibration images selected from the group consisting of barcodes and Quick Response (QR) codes.

In some embodiments, the method may comprise projecting at least one of the calibration features at or near a central region of the material surface. In some embodiments, the method may comprise generating the optical projection using one or more laser sources. In some embodiments, the one or more laser sources may comprise one or more line lasers. In some embodiments, the one or more laser sources may comprise one or more cross lasers.

In some embodiments, the method may comprise adjusting the position or orientation of the imaging unit based at least in part on an alignment between two or more laser lines projected by the one or more laser sources. In some embodiments, the method may comprise adjusting the position or orientation of the imaging unit based at least in part on a comparison of: (1) an image of the one or more projected calibration features having the one or more spatial characteristics, with (2) a reference image comprising a set of reference calibration features having a set of reference spatial characteristics. In some embodiments, adjusting the position or orientation of the imaging unit may comprise modifying a distance or an angle of the imaging unit relative to the material surface or the material fabrication machine.

In some embodiments, the method may comprise adjusting the position or the orientation of the imaging unit based at least in part on a depth map of the material surface. In some embodiments, the depth map may be obtained using a depth sensor. In some embodiments, the depth sensor may comprise a stereoscopic camera or a time-of-flight camera. In some embodiments, the depth map may comprise information on relative distances between the imaging unit and a plurality of points located on the material surface.

In some embodiments, the method may comprise adjusting the angle or the inclination of the material surface based at least in part on an alignment between two or more laser lines projected by the one or more laser sources. In some embodiments, the method may comprise adjusting the angle or inclination of the material surface based at least in part on a comparison of: (1) an image of the one or more projected calibration features having the one or more spatial characteristics, with (2) a reference image comprising a set of reference calibration features having a set of reference spatial characteristics. In some embodiments, the method may comprise adjusting the angle or inclination of the material surface based at least in part on a depth map of the material surface.

In some embodiments, the method may comprise adjusting the one or more imaging parameters based at least in part on an alignment between two or more laser lines projected by the one or more laser sources. In some embodiments, the method may comprise adjusting the one or more imaging parameters based at least in part on a comparison of: (1) an image of the one or more projected calibration features having the one or more spatial characteristics, with (2) a reference image comprising a set of reference calibration features having a set of reference spatial characteristics. In some embodiments, the method may comprise adjusting the one or more imaging parameters based at least in part on a depth map of the material surface.

In some embodiments, the method may further comprise using the imaging unit to determine at least a type, a shape, or a size of one or more defects within or on the material surface. In some embodiments, the material surface may be located on a roll-to-roll produced or processed material sheet. In some embodiments, the material fabrication machine may comprise a circular knitting machine or a weaving machine.

In another aspect, the present disclosure provides a method for calibration. The method may comprise (a) obtaining one or more images of a material surface that is provided in a material fabrication or processing machine, wherein the material surface comprises one or more calibration features, and wherein the one or more calibration features comprise one or more intentionally created defects, patterns, or features; (b) determining one or more spatial characteristics of the one or more calibration features, wherein the one or more spatial characteristics comprise one or more of the following: (i) a distance between the one or more calibration features, (ii) a position, (iii) an orientation, (iv) an alignment, (v) a size or (vi) a shape of the one or more calibration features; and (c) using the one or more spatial characteristics to adjust at least one of (i) a position or an orientation of an imaging unit relative to the material surface or relative to the material fabrication or processing machine, (ii) an angle or an inclination of the material surface relative to the imaging unit, and (iii) one or more imaging parameters of the imaging unit, wherein the one or more imaging parameters comprise an exposure time, a shutter speed, an aperture, a film speed, a field of view, an area of focus, a focus distance, a capture rate, or a capture time associated with the imaging unit.

In some embodiments, the one or more intentionally created defects, patterns, or features may be directly integrated into the material surface. In some embodiments, the one or more intentionally created defects, patterns, or features may be generated by adding one or more strings, threads, or yarns comprising a different color, dimension, or material into the material surface during a manufacturing or a processing of the material surface. In some embodiments, the one or more intentionally created defects, patterns, or features may be generated by adding or removing one or more strings, threads, or yarns to or from the material surface during a manufacturing or a processing of the material surface. In some embodiments, the addition or removal of the one or more strings, threads, or yarns to or from the material surface may produce one or more lines, patterns, gaps, or features within the material surface.

In another aspect, the present disclosure provides a method for calibration. The method may comprise (a) obtaining one or more images of a material surface that is provided in a material fabrication or processing machine, wherein the one or more calibration features comprise one or more calibration tools or calibration devices that are not optically projected onto the material surface; (b) determining one or more spatial characteristics of the one or more calibration features based on the one or more images, wherein the one or more spatial characteristics comprise one or more of the following: (i) a distance between the one or more calibration features, (ii) a position, (iii) an orientation, (iv) an alignment, (v) a size or (vi) a shape of the one or more calibration features; and (c) using the one or more spatial characteristics to adjust at least one of (i) a position or an orientation of an imaging unit relative to the material surface or relative to the material fabrication or processing machine, (ii) an angle or an inclination of the material surface relative to the imaging unit, and (iii) one or more imaging parameters of the imaging unit, wherein the one or more imaging parameters comprise an exposure time, a shutter speed, an aperture, a film speed, a field of view, an area of focus, a focus distance, a capture rate, or a capture time associated with the imaging unit.

In some embodiments, the one or more calibration tools or calibration devices may be affixed to the material surface or a portion thereof. In some embodiments, the one or more calibration tools or calibration devices may comprise one or more physical objects that are releasably attached or coupled to at least a portion of the material surface to aid in calibration. In some embodiments, the one or more physical objects may be coupled to the material surface using a pin, a clamp, a clip, a hook, a magnet, or an adhesive material. In some embodiments, the one or more calibration tools or calibration devices may comprise a label, a sticker, a barcode, a Quick Response (QR) code, or an image that is affixed or attached to the material surface. Such images, codes, labels, and/or stickers may be placed in an inspection zone (e.g., a portion of a material or material surface to be inspected) for camera calibration, and then removed after calibration.

In another aspect, the present disclosure provides a system for performing calibration. The system may comprise: an imaging unit configured to obtain one or more images of a material surface that is provided in a material fabrication or processing machine, wherein said material surface comprises one or more calibration features; and a calibration analysis unit configured to determine one or more spatial characteristics of the one or more calibration features based at least in part on the one or more images, wherein the one or more spatial characteristics comprise one or more of the following: (i) a distance between the one or more calibration features, (ii) a position, (iii) an orientation, (iv) an alignment, (v) a size or (vi) a shape of the one or more calibration features. The one or more spatial characteristics may be useable to adjust at least one of (i) a position or an orientation of an imaging unit relative to the material surface or relative to the material fabrication or processing machine, (ii) an angle or an inclination of the material surface relative to the imaging unit, and (iii) one or more imaging parameters of the imaging unit, wherein the one or more imaging parameters comprise an exposure time, a shutter speed, an aperture, a film speed, a field of view, an area of focus, a focus distance, a capture rate, or a capture time associated with the imaging unit. In some embodiments, the calibration analysis unit may be configured to provide feedback to the imaging unit. In some embodiments, the imaging unit may be calibrated based on the feedback.

In some embodiments, the system may further comprise a calibration unit configured to use the one or more spatial characteristics to adjust at least one of (i) a position or an orientation of an imaging unit relative to the material surface or relative to the material fabrication or processing machine, (ii) an angle or an inclination of the material surface relative to the imaging unit, and (iii) one or more imaging parameters of the imaging unit, wherein the one or more imaging parameters comprise an exposure time, a shutter speed, an aperture, a film speed, a field of view, an area of focus, a focus distance, a capture rate, or a capture time associated with the imaging unit.

In some embodiments, the system may further comprise a projection unit configured to generate an optical projection of one or more calibration features onto a material surface that is provided in a material fabrication or processing machine.

In some embodiments, the calibration unit may be configured to use said one or more spatial characteristics to adjust one or more operational parameters of the projection unit. The one or more operational parameters may comprise an intensity, a color, a brightness, a temperature, a wavelength, a frequency, a pulse width, a pulse frequency, or any other parameter that controls a transmission of light/electromagnetic waves or a physical characteristic of light/electromagnetic waves.

In some embodiments, the calibration methods of the present disclosure may comprise one or more dynamic calibration methods that can be implemented in real-time during a production or a processing of a textile material, a fabric, or a web using a material fabrication and processing machine. For example, the calibration methods may be used to dynamically optimize one or more image resolution metrics by adjusting one or more operational parameters of a light source or an imaging unit (e.g., light intensity, exposure time, position of the light source, orientation of the light source, etc.) as the textile material or web is being fabricated or processed.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the present disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings (also “Figure” and “FIG.” herein), of which:

FIG. 1 schematically illustrates a defect detection system, in accordance with some embodiments.

FIG. 2 schematically illustrates a plurality of zero dimensional calibration features, in accordance with some embodiments.

FIG. 3 schematically illustrates a plurality of one dimensional calibration features that are parallel, in accordance with some embodiments.

FIG. 4 schematically illustrates a plurality of one dimensional calibration features that are collinear, in accordance with some embodiments.

FIG. 5 schematically illustrates a two dimensional calibration feature, in accordance with some embodiments.

FIG. 6 schematically illustrates a calibration image, in accordance with some embodiments.

FIGS. 7A, 7B, 7C, 7D, 7E, and 7F schematically illustrate a plurality of calibration features generated using one or more line lasers and one or more cross lasers, in accordance with some embodiments.

FIG. 8 schematically illustrates a non-limiting example of an alignment of a camera relative to one or more laser sources, in accordance with some embodiments.

FIG. 9 schematically illustrates an adjustable mechanism configured to adjust a position and/or an orientation of one or more cameras and/or one or more laser sources relative to a material surface, in accordance with some embodiments.

FIG. 10 schematically illustrates a computer system that is programmed or otherwise configured to implement methods provided herein.

FIG. 11 schematically illustrates various examples of an optical detection system for defect detection and quality control that comprises a fixed camera.

FIG. 12 schematically illustrates various examples of an optical detection system for defect detection and quality control that comprises a movable or rotatable camera.

FIG. 13 schematically illustrates various inspection areas that may be monitored using an imaging system or an optical detection system for defect detection and quality control.

### DETAILED DESCRIPTION

While various embodiments of the disclosure have been shown and described herein, it will be obvious to those skilled in the art that such embodiments are provided by way of example only. Numerous variations, changes, and substitutions may occur to those skilled in the art without departing from the disclosure. It should be understood that various alternatives to the embodiments of the disclosure described herein may be employed.

As used herein, the term “material” generally refers to a product of a manufacturing process that may be subsequently utilized in one or more other manufacturing processes. For example, a knitting machine may produce a fabric material, which may be subsequently used to produce garments or other textile products. In another example, a metallurgical process may produce an untreated sheet metal material that may be subsequently used to cut parts or be formed into piping products.

As used herein, the term “product” generally refers to a composition produced from one or more manufactured materials by subsequent processing of the manufactured materials. For example, a knitted fabric material may be dyed, cut and sewn to produce a final garment product. A product may be an intermediate product or a final product.

As used herein, the term “defect” generally refers to an abnormality on the surface or within the volume of a material or product. Defects may include non-uniformities, non-conformities, misalignments, flaws, damages, aberrations, and irregularities in the material or product. As used herein, the term “regular defect” generally refers to a defect that repeats with a known pattern such as temporal recurrence, spatial recurrence, or repeating or similar morphology (e.g., holes of the same shape or size). As used herein, an “irregular defect” generally refers to a defect with a non-patterned recurrence such as temporal randomness, spatial randomness, or differing or dissimilar morphology (e.g., holes of random shapes or sizes).

As used herein, the term “calibrate,” “calibrating,” or “calibration” generally refers to adjusting, modifying, refining, changing, updating, adapting, and/or reconfiguring one or more components of a defect detection system to enable the defect detection system to detect one or more defects at a desired level of accuracy or precision. Calibrating may involve adjusting, modifying, refining, changing, updating, adapting, and/or reconfiguring one or more components of a defect detection system to reduce or eliminate a number of false positive and/or a number of false negatives that may occur when the defect detection system is used to detect one or more defects within a material surface, a plurality of material surfaces, or one or more target regions within a material surface. Calibrating may involve adjusting a position or an orientation of one or more components of a defect detection system (e.g., one or more defect imaging units, one or more cameras, one or more light sources, and/or one or more image analysis units) relative to one or more target regions of a material sheet. Calibrating may involve adjusting a position or an orientation of one or more components of a defect detection system (e.g., one or more defect imaging units, one or more cameras, one or more light sources, and/or one or more image analysis units) relative to one or more components of a material fabrication or processing machine. The calibrating may include providing defect imaging unit(s) in a predetermined spatial configuration relative to a material fabrication machine that is useable to form the material sheet. The calibrating may also include providing the one or more defect imaging units in a predetermined spatial configuration for imaging one or more target regions on a material surface, such that the defect imaging unit(s) are in focus on the target region(s), and the target region(s) lie within a field of view of the defect imaging unit(s). The calibrating may further include adjusting, modifying, refining, changing, updating, adapting, and/or reconfiguring an operation of one or more components of a defect detection system. Calibrating may also include one or more real-time changes or adjustments to a spatial configuration, a hardware configuration, a software configuration, or an operation of one or more components of a defect detection system. As used herein, the term “target region(s)” generally refers to one or more regions that are defined on a material sheet. The target region(s) may be of any predetermined shape, size, or dimension.

As used herein, the term “quality” generally refers to a desired or predetermined qualitative or quantitative property (or properties) of a material or product. A quality may encompass a plurality of properties that collectively form a standard for a material. For example, a quality of a textile may refer to a length, width, depth, thickness, diameter, circumference, dimension, shape, density, weight, color, thread count, strength, elasticity, softness, smoothness, durability, absorbency, fabric uniformity, yarn material, yarn uniformity, yarn thickness, or appearance of the textile, or a combination thereof. As used herein, the term “substandard quality” generally refers to a material or product that fails to meet at least one quality control standard or benchmark for a desired property. In some cases, a substandard material or product may fail to meet more than one quality control standard or benchmark.

As used herein, the term “quality control” generally refers to an evaluation, determination, or assessment of a quality or a property of a material, or a method of comparing a manufactured material or product to an established quality control standard or benchmark. A quality control method may comprise measuring one or more observable properties or parameters (e.g., length, width, depth, thickness, diameter, circumference, dimension, shape, color, density, weight, thread count, strength, elasticity, softness, smoothness, durability, absorbency, fabric uniformity, yarn material, yarn uniformity, yarn thickness, appearance, etc.) of a manufactured material or product. Quality control may comprise comparison of one or more parameters of a material or product to a known benchmark or monitoring of variance of one or more parameters during a manufacturing process. Quality control may be qualitative (e.g., pass/fail) or quantitative (e.g., statistical analysis of measured parameters). A manufacturing process may be considered to meet a quality control standard if the variance of at least one material or product parameter is within about ±1%, ±2%, ±3%, ±4%, ±5%, ±6%, ±7%, ±8%, ±9%, or about ±10% of a quality control standard or benchmark.

The term “real-time,” as used herein, generally refers to a simultaneous or substantially simultaneous occurrence of a first event or action with respect to an occurrence of a second event or action. A real-time action or event may be performed within a response time of less than one or more of the following: ten seconds, five seconds, one second, a tenth of a second, a hundredth of a second, a millisecond, or less relative to at least another event or action. A real-time action may be performed by one or more computer processors.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The terms “a,” “an,” and “the,” as used herein, generally refer to singular and plural references unless the context clearly dictates otherwise.

In an aspect, the present disclosure provides a method for calibration. The method may comprise: (a) generating an optical projection of one or more calibration features onto a material surface. As described herein, a material surface may refer to a surface of a material. Alternatively, a material surface may refer to a portion of a surface of a material. The material may comprise one or more textiles, metals, papers, polymers, composites, and/or ceramics. The terms “material” and “material surface” as referred to herein may encompass and may be used interchangeably with the terms “web”, “fabric”, “sheet,” or “textile.”

Textiles may include any product produced from the spinning of fibers into long strands. Textiles may include yarns as well as products produced from the weaving or knitting of fibers into continuous fabrics. Textiles may be produced from natural or synthetic fibers. Natural fibers may include cotton, silk, hemp, bast, jute, wool, bamboo, sisal, and flax. Synthetic fibers may include nylon, rayon, polyester, acrylic, spandex, glass fiber, dyneema, orlon, and Kevlar. Textiles may be produced from a combination of fiber types such as cotton and polyester. Textiles may include additional components such as plastics and adhesives (e.g., carpet). Produced textiles may undergo additional processing such as desizing, scouring, bleaching, mercerizing, singeing, raising, calendering, shrinking, dyeing and printing.

Metals may include any metal, metal oxide or alloy products. Metals may include steels such as carbon steels and stainless steels. Metals may include pure metals such as copper and aluminum. Metals may include common alloys such as bronze and brass. Metals may be manufactured or cast in forms such as sheets, rods, and foils. Metals may undergo additional processing such as rolling, annealing, quenching, hardening, pickling, cutting, and stamping.

Papers may include any product produced from plant pulp such as sheet paper and cardboard. Paper products may include other materials such as plastics, metals, dyes, inks, and adhesives. Paper may undergo additional processes before or after productions such as bleaching, cutting, folding, and printing.

Polymers may include polymer materials such as thermoplastics, crystalline plastics, conductive polymers and bioplastics. Exemplary polymers may include polyethylene, polypropylene, polyamides, polycarbonates, polyesters, polystyrenes, polyurethanes, polyvinyl chlorides, acrylics, teflons, polyetheretherketones, polyimides, polylactic acids, and polysulfones. Polymers may include rubbers and elastic materials. Polymers may include copolymers or composites of multiple polymers. Polymeric materials may incorporate other materials such as paper, metal, dyes, inks, and minerals. Polymeric materials may undergo additional processes after manufacture such as molding, cutting, and dying. Plastic products may include food containers, sheets and wraps, housing materials and innumerable other consumer products.

Ceramics may include a broad range of crystalline, semi-crystalline, vitrified, or amorphous inorganic solids. Ceramic products may include earthenware, porcelain, brick and refractory materials. Ceramics may range from materials that are transparent in the visible spectrum, such as glass, to non-transparent materials in the visible spectrum, such as bricks. Ceramics may form composites with other materials such as metals and fibers. Ceramics products may undergo processes such as molding, hardening, cutting, glazing, and/or painting during manufacturing.

Composites may include any material that comprises two or more other types of materials. Exemplary composites may include building materials such as particle board and concrete, as well as other structural materials such as metal-carbon fiber composites. Composite materials may undergo similar additional processing methods as their substituent components.

The material may be produced and/or provided in one or more form factors. The one or more form factors may comprise sheets, nets, webs, films, tubes, blocks, rods, rolls, and/or discs.

In some cases, the material surface may be substantially flat. In other cases, the material surface may not be substantially flat. In some cases, the material surface may comprise one or more surface irregularities. The one or more surface irregularities may comprise a defect. Defects in the material surface may comprise holes, cracks, fractures, pits, pores, depressions, tears, burns, stains, bends, breaks, domains of thinning, domains of thickening, stretches, compressions, bulges, protrusions, deformations, discontinuities, missing substituents, blockages, occlusions, and/or unwanted inclusions.

The material surface may be provided in a material fabrication or processing machine. A material fabrication machine may comprise a machine that is configured to produce a material having one or more form factors described above. In some cases, the material fabrication machine may comprise a circular knitting machine or a weaving machine. A material processing machine may comprise a machine that is configured to process a material. Processing a material may comprise, for example, cutting, sewing, ironing, de-linting, desizing, scouring, bleaching, mercerizing, singeing, raising, calendering, shrinking, dyeing, printing, rolling, annealing, quenching, hardening, pickling, cutting, and/or stamping the material or a portion of the material. In some cases, the material surface may be located on a roll-to-roll produced or processed material sheet. The roll-to-roll produced or processed material sheet may be fabricated or processed using any one or more material fabrication or processing machines described herein.

As described above, the method may comprise generating an optical projection of one or more calibration features onto a material surface. An optical projection may comprise a visual projection of one or more images onto a surface using one or more light sources. The one or more images may comprise one or more calibration features, as described in greater detail below. The surface may comprise a material surface as described elsewhere herein.

The optical projection of the one or more calibration features may be generated using one or more light sources. The one or more light sources may comprise a single light, a group of lights, or a series of lights. The one or more light sources may comprise a substantially monochromatic light source or a light source with a characteristic frequency or wavelength range. Exemplary light sources may include x-ray sources, ultraviolet (UV) sources, infrared sources, LEDs, fluorescent lights, and/or lasers. The one or more light sources may emit one or more light beams or light pulses within a defined region of the electromagnetic spectrum, such as x-ray, UV, UV-visible, visible, near-infrared, far-infrared, or microwave. The one or more light sources may have a characteristic wavelength of about 0.1 nanometer (nm), 1 nm, 10 nm, 100 nm, 200 nm, 300 nm, 400 nm, 500 nm, 600 nm, 700 nm, 800 nm, 900 nm, 1 micrometer (μm), 10 μm, 100 μm, 1 millimeter (mm), or more than about 1 mm. The one or more light sources may have a characteristic wavelength of at least about 0.1 nm, 1 nm, 10 nm, 100 nm, 200 nm, 300 nm, 400 nm, 500 nm, 600 nm, 700 nm, 800 nm, 900 nm, 1 μm, 10 μm, 100 μm, 1 mm, or more than 1 mm. The one or more light sources may have a characteristic wavelength of no more than about 1 mm, 100 μm, 10 μm, 1 μm, 900 nm, 800 nm, 700 nm, 600 nm, 500 nm, 400 nm, 300 nm, 200 nm, 100 nm, 10 nm, 1 nm, 0.1 nm, or less than about 0.1 nm. The one or more light sources may emit a range of wavelengths, for example in a range from about 1 nm to about 10 nm, about 1 nm to about 100 nm, about 10 nm to about 100 nm, about 10 nm to about 400 nm, about 100 nm to about 500 nm, about 100 nm to about 700 nm, about 200 nm to about 500 nm, about 400 nm to about 700 nm, about 700 nm to about 1 μm, about 700 nm to about 10 μm, about 1 μm to about 100 μm, or about 1 μm to about 1 mm.

The one or more light sources may be provided in a predetermined position relative to the material surface. The predetermined position may comprise a predetermined distance from the material surface. The predetermined distance may correspond to a distance between the one or more light sources and a reference point on the material surface. The reference point may be located anywhere on the material surface. In some cases, the reference point may be located at or near a center of the material surface. The predetermined distance may be at least about 1 millimeter (mm), 2 mm, 3 mm, 4 mm, 5 mm, 6 mm, 7 mm, 8 mm, 9 mm, 1 centimeter (cm), 2 cm, 3 cm, 4 cm, 5 cm, 6 cm, 7 cm, 8 cm, 9 cm, 10 cm, 20 cm, 30 cm, 40 cm, 50 cm, 60 cm, 70 cm, 80 cm, 90 cm, 1 meter (m), 2 m, 3 m, 4 m, 5 m, 6 m, 7 m, 8 m, 9 m, 10 m, or more.

The one or more light sources may be provided in a predetermined orientation relative to the material surface. The predetermined orientation may correspond to an angular orientation of the one or more light sources relative to a reference point on the material surface. The reference point may be located anywhere on the material surface. In some cases, the reference point may be located at or near a center of the material surface. The angular orientation of the one or more light sources relative to the material surface may be substantially horizontal or low angle. The angular orientation of the one or more light sources relative to the material surface may be substantially orthogonal. In some cases, the one or more light sources may be oriented relative to the material surface at about 0°, 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29°, 30°, 31°, 32°, 33°, 34°, 35°, 36°, 37°, 38°, 39°, 40°, 41°, 42°, 43°, 44°, 45°, 46°, 47°, 48°, 49°, 50°, 51°, 52°, 53°, 54°, 55°, 56°, 57°, 58°, 59°, 60°, 61°, 62°, 63°, 64°, 65°, 66°, 67°, 68°, 69°, 70°, 71°, 72°, 73°, 74°, 75°, 76°, 77°, 78°, 79°, 80°, 81°, 82°, 83°, 84°, 85°, 86°, 87°, 88°, 89°, 90°, 95°, 100°, 105°, 110°, 115°, 120°, 125°, 130°, 135°, 140°, 145°, 150°, 155°, 160°, 165°, 170°, 175°, or about 180°. In some cases, the one or more light sources may be oriented relative to the material surface at an angle that is at least about 0°, 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29°, 30°, 31°, 32°, 33°, 34°, 35°, 36°, 37°, 38°, 39°, 40°, 41°, 42°, 43°, 44°, 45°, 46°, 47°, 48°, 49°, 50°, 51°, 52°, 53°, 54°, 55°, 56°, 57°, 58°, 59°, 60°, 61°, 62°, 63°, 64°, 65°, 66°, 67°, 68°, 69°, 70°, 71°, 72°, 73°, 74°, 75°, 76°, 77°, 78°, 79°, 80°, 81°, 82°, 83°, 84°, 85°, 86°, 87°, 88°, 89°, 90°, 95°, 100°, 105°, 110°, 115°, 120°, 125°, 130°, 135°, 140°, 145°, 150°, 155°, 160°, 165°, or more. In some cases, the one or more light sources may be oriented relative to the material surface at an angle that is at most about 180°, 175°, 170°, 165°, 160°, 155°, 150°, 145°, 140°, 135°, 130°, 125°, 120°, 115°, 110°, 105°, 100°, 95°, 90°, 89°, 88°, 87°, 86°, 85°, 84°, 83°, 82°, 81°, 80°, 79°, 78°, 77°, 76°, 75°, 74°, 73°, 72°, 71°, 70°, 69°, 68°, 67°, 66°, 65°, 64°, 63°, 62°, 61°, 60°, 59°, 58°, 57°, 56°, 55°, 54°, 53°, 52°, 51°, 50°, 49°, 48°, 47°, 46°, 45°, 44°, 43°, 42°, 41°, 40°, 39°, 38°, 37°, 36°, 35°, 34°, 33°, 32°, 31°, 30°, 29°, 28°, 27°, 26°, 25°, 24°, 23°, 22°, 21°, 20°, 19°, 18°, 17°, 16°, 15°, 14°, 11°, 12°, 11°, 10°, 9°, 8°, 7°, 6°, 5°, 4°, 3°, 2°, 1°, or less.

In some cases, the one or more light sources may be positioned in front of the material surface. In such cases, each of the one or more light sources positioned in front of the material surface may be configured to optically project one or more calibration features onto the material surface along a projection path that is substantially orthogonal to the material surface or a portion thereof. In such cases, one or more aspects of computer vision may be used to determine a distance and/or an angle to the material surface.

In other cases, the one or more light sources may be positioned above and/or below the material surface such that the one or more calibration features are projected along a projection path that intersects the material surface at an angle. The projection path may not or need not be orthogonal to the material surface. In some cases, the angle at which the projection path intersects the material surface may be less than 90°, or greater than 90°.

In some cases, the one or more light sources may be positioned to the left and/or to the right of the material surface such that the one or more calibration features are projected along a projection path that intersects the material surface at an angle. The projection path may not or need not be orthogonal to the material surface. In some cases, the angle at which the projection path intersects the material surface may be less than 90° or greater than 90°.

As described above, the one or more light sources may be used to optically project one or more calibration features onto a material surface. The one or more calibration features projected onto the material surface may comprise one or more visual features that may be generated using any one or more light sources described elsewhere herein. In some cases, the one or more light sources may comprise one or more laser light sources.

The one or more calibration features may comprise an optical feature, shape, and/or pattern that may be used to perform a calibration procedure. A calibration procedure may comprise adjusting at least one of (i) a position or an orientation of a defect detection and quality control system relative to a material surface and/or a material fabrication or processing machine, (ii) an angle or an inclination of a material surface relative to the defect detection and quality control system, and/or (iii) an imaging parameter of the defect detection and quality control system. The imaging parameter may comprise an exposure time, a shutter speed, an aperture, a film speed, a field of view, an area of focus, a focus distance, a capture rate, or a capture time associated with the defect detection device or a component thereof. In some cases, one or more imaging parameters of the defect detection and quality control system may be adjusted during an installation process for the defect detection and quality control system, or dynamically during a manufacturing, processing, or production of one or more materials or textiles. In some cases, the calibration procedure may comprise adjusting (iv) one or more lighting parameters of the defect detection and quality control system. The one or more lighting parameters may be associated with one or more light sources (e.g., one or more light sources used to illuminate a material surface for imaging, or one or more laser light sources used to optically project calibration features onto the material surface) which may be used with the defect detection and quality control systems of the present disclosure. The one or more lighting parameters may comprise a power or an intensity of one or more light beams or light pulses generated by the one or more light sources, a flash interval, a period of time or a duration during which the one or more light sources are operational, a rate at which the one or more light sources are flashed (i.e., turned on and off), and/or a length of time between two or more successive flashes. In some cases, the one or more lighting parameters may comprise a position and/or an orientation of one or more light sources relative to (i) the material surface or (ii) one or more imaging units of the defect detection and quality control system.

The defect detection and quality control system may comprise a defect imaging unit. The defect imaging unit may be configured to image, identify, classify, and/or detect one or more defects in a material surface. The defect imaging unit may be configured to identify, classify, and/or detect one or more defects in a material surface based on one or more images of the material surface. In some cases, the defect imaging unit may be configured to determine a quality of a material or a material surface that is fabricated or processed using a material fabrication or processing machine. In some cases, the defect imaging unit may be used for quality control before, during, or after the fabrication or processing of one or more materials or products using a material fabrication or processing machine. In some cases, a calibration procedure may comprise adjusting (i) a position or an orientation of a material surface and/or a material fabrication or processing machine relative to the defect imaging unit. In some cases, a calibration procedure may comprise adjusting (ii) an angle or an inclination of a material surface relative to the defect imaging unit. In some cases, a calibration procedure may comprise adjusting (iii) an imaging parameter associated with the defect imaging unit. The imaging parameter may comprise an exposure time, a shutter speed, an aperture, a film speed, a field of view, an area of focus, a focus distance, a capture rate, or a capture time associated with the defect imaging unit. In some cases, the calibration procedure may comprise adjusting a lighting parameter as described elsewhere herein. In any of the embodiments described herein, the calibration procedure may be performed before fabrication or processing of one or more materials or products (e.g., during an installation process of the defect detection and quality control system), or dynamically during normal textile production, fabrication, or processing.

As used herein, a defect imaging unit may refer to and/or encompass any system or device capable of detecting and/or capturing images of material defects or substandard materials or products via the transmission, reflection, refraction, scattering or absorbance of light. The defect imaging unit may be configured to recognize defects and/or identify substandard materials or products that do not meet a desired or predetermined quality control standard or benchmark for one or more qualitative or quantitative properties. The defect imaging unit may be configured to detect defects in one or more materials and/or determine a quality of one or more materials (e.g., for quality control). The one or more materials may be produced at very high throughput rates where defect detection and quality control requirements may exceed the ability of humans to recognize and remove defective products. The implementation of automated quality control or defect detection methods using the systems and methods disclosed herein may permit enhanced process control in the absence of available quality assurance personnel, for example during night shifts.

The defect imaging unit may be configured to determine at least a type, a shape, or a size of one or more defects within or on a material surface. Defects on a material or product surface or body may have a characteristic behavior in the presence of a light source. For example, holes, tears, blockages, or occlusions may all be characterized by changes in the transmission of light. In another example, surface flaws such as pits or bulges may be detected by changes in the reflection or scattering patterns of an impinging light source. In some cases, the defect imaging unit may be configured to determine a quality of a material for quality control during fabrication or processing of the material using a material fabrication or processing machine. In some cases, the defect imaging unit may be configured to identify substandard materials that do not have a desired or predetermined level of quality. Substandard materials may be measured by bulk parameters or may be assessed by other measures such as statistical analysis of detected defects.

The defect detection and quality control systems of the present disclosure may comprise one or more cameras or imaging sensors. The one or more cameras or imaging sensors may be part of a defect imaging unit, or may correspond to an image capture device associated with a calibration analysis unit as described elsewhere herein. The one or more cameras or imaging sensors may be positioned adjacent to or in close proximity to the material fabrication and processing machine. The one or more cameras or imaging sensors may be external to the material fabrication and processing machine. The one or more cameras or imaging sensors may be provided inside a circular knitting machine. As used herein, “inside a circular knitting machine” may refer to a placement of the one or more cameras or imaging sensors within a perimeter or physical footprint of the circular knitting machine. In some cases, “inside a circular knitting machine” may refer to a placement of the one or more cameras or imaging sensors near one or more internal regions, edges, or components of the circular knitting machine.

In some cases, the one or more cameras or imaging sensors may be provided inside a fabrics tube of a circular knitting machine. In other cases, the one or more cameras or imaging sensors may be provided outside of a fabrics tube of a circular knitting machine.

In some embodiments, the one or more cameras or imaging sensors may be fixed to a rotational structure or component of the circular knitting machine. The one or more cameras or imaging sensors may be used to acquire images and/or videos of a manufactured material as the rotational structure or component is moving (e.g., rotating) relative to a material surface. The one or more cameras or imaging sensors may be used to acquire images and/or videos of a manufactured material as the one or more cameras or imaging sensors are moving (e.g., rotating) relative to a material surface. In some cases, the one or more cameras or imaging sensors may be fixed to the circular knitting machine (e.g., fixed to a structural component of the circular knitting machine) and configured to capture images and/or videos of the manufactured web as the web is rotating. In some cases, the one or more cameras or imaging sensors may be fixed to the circular knitting machine and configured to capture images and/or videos of the web from inside a tubular portion of the circular knitting machine. In some cases, the one or more cameras or imaging sensors may be fixed to a rotational structure of the circular knitting machine and configured to acquire images and/or videos of the manufactured web from inside a tubular portion of the circular knitting machine.

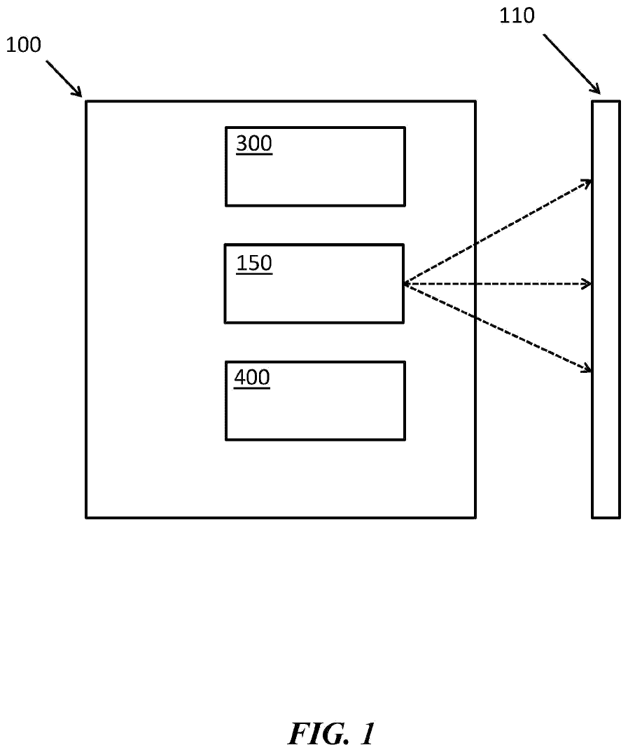

FIG. 1 illustrates a defect detection and quality control system 100 that may be calibrated using any one or more calibration methods or systems disclosed herein. The defect detection and quality control system 100 may be configured to detect one or more defects in, on, or within a material surface 110. In any of the embodiments described herein, the one or more defects in, on, or within a material surface 110 may comprise one or more intentionally created defects that may be used for calibration and/or quality control. In some cases, the defect detection and quality control system 100 may be configured to determine a quality of the material surface 110 for quality control before, during, and/or after the material surface 110 undergoes a manufacturing process or a processing step. In some cases, the material surface 110 may be provided separately or remotely from the defect detection and quality control system 100. In other cases, the material surface 110 may be provided as a part or a component of the defect detection and quality control system 100. In some cases, the defect detection system may comprise a material fabrication or processing machine as described above. In other cases, the material fabrication or processing machine may be provided separately or remotely from the defect detection and quality control system 100. In some embodiments, the material surface 110 may be provided in the material fabrication or processing machine.

In some embodiments, the defect detection and quality control system 100 may comprise a projection unit 150. The projection unit 150 may comprise one or more light sources as described herein. The projection unit 150 may be configured to optically project one or more visual features onto the material surface 110. The one or more visual features may comprise one or more calibration features as described elsewhere herein.

In some embodiments, the defect detection and quality control system 100 may comprise a calibration analysis unit 300. The calibration analysis unit 300 may comprise one or more image capture devices (e.g., one or more cameras). The calibration analysis unit 300 may be configured to obtain and/or capture one or more images of the material surface 110. The material surface 110 may comprise the one or more calibration features optically projected onto the material surface 110 by the projection unit 150. In some cases, the calibration analysis unit 300 may be configured to implement an image processing algorithm to process the one or more images of the material surface 110 to determine one or more spatial characteristics of the one or more calibration features based at least in part on the optical projection of the one or more calibration features onto the material surface 110. In some cases, the calibration analysis unit 300 may be configured to implement an image processing algorithm to process the one or more images of the material surface 110 to determine one or more spatial characteristics of the one or more calibration features based at least in part on the one or more images. As used herein, an image processing algorithm may be referred to interchangeably as a defect detection algorithm.

In some cases, the calibration analysis unit 300 may be configured to implement a quality control algorithm to determine if substandard materials or products are being fabricated or processed. The quality control algorithm may be configured to recognize regular or repeating defects or regular substandard materials or products that may evidence a broken or malfunctioning material fabrication or processing machine. The quality control algorithm may be programmed to alert a human operator or automatically stop a material fabrication process or a material processing step if a defect detection rate exceeds a threshold level or if a quality control standard falls below a threshold level.

The image processing algorithm and the quality control algorithm may comprise one or more algorithms for interpreting imaging data to determine the presence of defects or substandard materials or products in a manufactured material or product. An algorithm may be a standalone software package or application for defect detection and quality control. An algorithm may be integrated with other operational software for a manufacturing device, such as process control software. An algorithm for defect detection or quality control may be used to aid in a calibration of any of the defect detection and quality control systems described herein. An algorithm for defect detection or quality control may be configured to adjust the operation of a manufacturing process. For example, a defect detection algorithm or quality control algorithm may be configured to stop or slow a manufacturing process if one or more defects are detected in a material or product, or if a material or product falls beneath a quality control standard for a certain amount of time. A defect detection algorithm or quality control algorithm may be capable of identifying one or more types of defects or quality levels in a manufactured material or product. A defect detection algorithm or quality control algorithm may be capable of identifying a root cause of one or more types of defects or substandard materials or products based upon the number of defects, the number density of defects, the frequency of defects, the regularity of defects, the size of defects, the shape of defects, or any other relevant parameters that may be calculated by the algorithm. A defect detection algorithm or quality control algorithm may utilize defect data to stop or alter a manufacturing process. A defect detection algorithm or quality control algorithm may correct one or more processing parameters to reduce the rate of defect formation or improve the quality of a material or product during a manufacturing process. A defect detection algorithm or quality control algorithm may identify an unusable, unsellable, or otherwise compromised material or product obtained from a manufacturing process. A material or product may be discarded, repaired, or reprocessed based upon the identification of one or more defects or substandard quality by a defect detection algorithm or quality control algorithm. A defect detection algorithm or quality control algorithm may comprise a trained algorithm or a machine learning algorithm. A defect detection algorithm or quality control algorithm may comprise a trained algorithm or a machine learning algorithm. In some cases, the defect detection algorithm or quality control algorithm may comprise a machine or computer vision algorithm. The defect detection algorithm or quality control algorithm may comprise various sub-algorithms or subroutines such as variance analysis, Gaussian kernel convolution, machine learning models (e.g., section profile analysis), local binary pattern analysis, gradient analysis, and/or Hough transform analysis.

In some cases, the calibration analysis unit 300 may be configured to determine if the defect detection and quality control system 100 and/or a defect imaging unit of the defect detection and quality control system 100 is in a calibrated state or an uncalibrated state, as described in greater detail below. In some cases, the calibration analysis unit 300 may be configured to determine whether the defect detection and quality control system 100 and/or a defect imaging unit of the defect detection and quality control system 100 is in a calibrated state or an uncalibrated state based at least in part on a comparison of (i) the one or more spatial characteristics of the one or more calibration features and (ii) a set of reference spatial characteristics associated with a set of reference calibration features within a reference image. In some cases, the calibration analysis unit 300 may be configured to determine an amount of calibration required for the defect detection and quality control system 100 to reliably and accurately detect defects in a material or determine a quality of a material for quality control before, during, or after fabrication or processing of the material. In some cases, the calibration analysis unit 300 may be configured to determine which adjustments or combinations of adjustments should be made in order to calibrate the defect detection and quality control system. The adjustments or combinations of adjustments may comprise one or more adjustments to (i) a position or an orientation of the defect detection and quality control system relative to the material surface or relative to a material fabrication or processing machine, (ii) an angle or an inclination of the material surface relative to the defect detection and quality control system, (iii) one or more imaging parameters of the defect detection and quality control system, and/or (iv) one or more lighting parameters of the defect detection and quality control system.

In any of the embodiments described herein, one or more operational aspects of the calibration analysis unit 300 may be replaced or augmented by one or more actions performed by a human operator. In some cases, a human operator may take the place of the calibration analysis unit 300. In any of the embodiments described herein, a human operator may perform one or more aspects of defect detection and quality control that may be implemented or performed using the defect detection and quality control systems of the present disclosure. For example, the human operator may visually assess the material surface to identify a level of quality of the material surface or to identify one or more defects in the material surface. In some cases, the human operator may visually determine one or more spatial characteristics associated with a plurality of calibration features that are optically projected onto, attached to, integrated into, and/or visible on the material surface or a portion thereof. In some cases, the human operator may visually compare a first set of spatial characteristics associated with the plurality of calibration features to a second set of spatial characteristics associated with a plurality of reference features visible on a reference image. In some cases, the human operator may determine whether the defect detection and quality control system is calibrated based on a comparison of a first set of spatial characteristics associated with the plurality of calibration features to a second set of spatial characteristics associated with a plurality of reference features visible within a reference image. In some cases, the human operator may use the one or more spatial characteristics to determine which adjustments should be made to calibrate the defect detection and quality control system. As described elsewhere herein, the adjustments may comprise one or more adjustments to at least one of (i) a position or an orientation of the defect detection and quality control system relative to the material surface or relative to the material fabrication or processing machine, (ii) an angle or an inclination of the material surface relative to the defect detection and quality control system, (iii) one or more imaging parameters of the defect detection and quality control system, or (iv) one or more lighting parameters of the defect detection and quality control system. In some cases, the human operator may use the one or more spatial characteristics to determine an amount of adjustment needed to calibrate the defect detection and quality control system.

In some embodiments, the defect detection and quality control system 100 may comprise a defect imaging unit 400. The defect imaging unit 400 may comprise any system or device capable of detecting and/or capturing images of material defects or substandard materials or products via the transmission, reflection, refraction, scattering or absorbance of light. The defect imaging unit 400 may be configured to determine at least a type, a shape, or a size of one or more defects within or on a material surface. Defects on a material or product surface or body may have a characteristic behavior in the presence of a light source. For example, holes, tears, blockages, or occlusions may all be characterized by changes in the transmission of light. In another examples, surface flaws such as pits or bulges may be detected by changes in the reflection or scattering patterns of an impinging light source. In some embodiments, the defect imaging unit 400 may comprise any system or device that may be used to assess a quality of a material that is fabricated or processed by a material fabrication or processing machine. In some cases, the defect imaging unit 400 may be configured to aid in quality control by identifying substandard materials that do not have a desired or predetermined level of quality. Substandard materials may be measured by bulk parameters or may be assessed by other measures such as statistical analysis of detected defects.

As described above, a projection unit of the defect detection and quality control system may be configured to optically project one or more calibration features onto the material surface. In some cases, the one or more calibration features may comprise one or more zero-dimension (0-D) features. The one or more zero-dimensional (0-D) features may comprise one or more dots. In some cases, the one or more dots may comprise one or more laser dots.

In some cases, the one or more calibration features may comprise a plurality of dots or a plurality of laser dots. The plurality of dots may comprise at least 1 dot, 2 dots, 3 dots, 4 dots, 5 dots, 6 dots, 7 dots, 8 dots, 9 dots, 10 dots, 11 dots, 12 dots, 13 dots, 14 dots, 15 dots, 16 dots, 17 dots, 18 dots, 19 dots, 20 dots, or more. The plurality of laser dots may comprise at least 1 laser dot, 2 laser dots, 3 laser dots, 4 laser dots, 5 laser dots, 6 laser dots, 7 laser dots, 8 laser dots, 9 laser dots, 10 laser dots, 11 laser dots, 12 laser dots, 13 laser dots, 14 laser dots, 15 laser dots, 16 laser dots, 17 laser dots, 18 laser dots, 19 laser dots, 20 laser dots, or more.

The plurality of dots or laser dots may have a dot size. The dot size may be at least about 1 millimeter (mm), 2 mm, 3 mm, 4 mm, 5 mm, 6 mm, 7 mm, 8 mm, 9 mm, 1 centimeter (cm), 2 cm, 3 cm, 4 cm, 5 cm, 6 cm, 7 cm, 8 cm, 9 cm, 10 cm, 20 cm, 30 cm, 40 cm, 50 cm, 60 cm, 70 cm, 80 cm, 90 cm, 1 meter (m), 2 m, 3 m, 4 m, 5 m, 6 m, 7 m, 8 m, 9 m, 10 m, or more.

The plurality of dots may be separated by one or more separation distances. The one or more separation distances may be the same. Alternatively, the one or more separation distances may be different. The one or more separation distances may be at least about 1 millimeter (mm), 2 mm, 3 mm, 4 mm, 5 mm, 6 mm, 7 mm, 8 mm, 9 mm, 1 centimeter (cm), 2 cm, 3 cm, 4 cm, 5 cm, 6 cm, 7 cm, 8 cm, 9 cm, 10 cm, 20 cm, 30 cm, 40 cm, 50 cm, 60 cm, 70 cm, 80 cm, 90 cm, 1 meter (m), 2 m, 3 m, 4 m, 5 m, 6 m, 7 m, 8 m, 9 m, 10 m, or more.

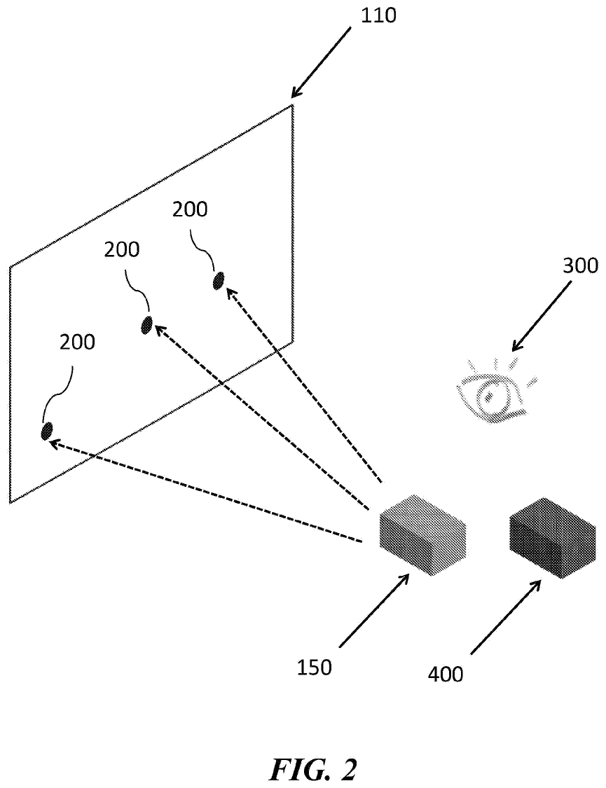

FIG. 2 illustrates a material surface 110 onto which a projection unit 150 may optically project one or more calibration features 200. The projection unit 150 may comprise one or more light sources as described herein. The one or more light sources may comprise one or more laser light sources. The one or more calibration features 200 may comprise a plurality of dots. In any of the embodiments described herein, the one or more calibration features 200 may comprise one or more intentionally created defects. The one or more intentionally created defects may be directly integrated into the material surface 110 or a portion thereof. In some cases, a calibration analysis unit 300 may be configured to obtain and/or capture one or more images of the material surface 110 with the plurality of dots 200 optically projected onto the material surface 110. In some cases, the calibration analysis unit 300 may be configured to implement an image processing algorithm to process the one or more images of the material surface 110 to determine one or more spatial characteristics of the plurality of dots based at least in part on the optical projection of the plurality of dots. The one or more spatial characteristics may comprise one or more of the following: (i) a distance between two or more dots, (ii) a relative position of the plurality of dots, (iii) a relative orientation of the plurality of dots, (iv) a relative alignment of the plurality of dots in relation to one another, (v) a size of the plurality of dots, or (vi) a shape of the plurality of dots. In some cases, a human operator (e.g., an operator of a material fabrication or processing machine) may visually determine the one or more spatial characteristics associated with the plurality of dots projected onto the material surface 110. In some cases, the calibration analysis unit 300 may be configured to implement a quality control algorithm as described elsewhere herein.

In some embodiments, the one or more spatial characteristics may be usable to adjust a position and/or an orientation of a defect imaging unit 400. For example, the one or more spatial characteristics may be usable to adjust a position and/or an orientation of a defect imaging unit 400 relative to the material surface 110. In another example, the one or more spatial characteristics may be usable to adjust a position and/or an orientation of a defect imaging unit 400 relative to a material fabrication or processing machine used to fabricate and/or process the material surface 110. In another example, the one or more spatial characteristics may be usable to adjust an angle or an inclination of the material surface 110 relative to the defect imaging unit 400. In another example, the one or more spatial characteristics may be usable to adjust one or more imaging parameters associated with the defect detection and quality control system or a component of the defect detection and quality control system (e.g., a defect imaging unit). The one or more imaging parameters may comprise an exposure time, a shutter speed, an aperture, a film speed, a field of view, an area of focus, a focus distance, a capture rate, or a capture time associated with the defect imaging unit. In another example, the one or more spatial characteristics may be usable to adjust one or more lighting parameters associated with the defect detection and quality control system or a component of the defect detection and quality control system (e.g., a defect imaging unit).

In some cases, the calibration analysis unit 300 may determine that the defect detection and quality control system is calibrated when a first set of spatial characteristics associated with the plurality of dots corresponds to a second set of spatial characteristics associated with a plurality of reference features projected onto a reference image, as described in greater detail below. The plurality of reference features may comprise a plurality of reference dots. The plurality of reference dots may have a set of reference spatial characteristics that correspond to a set of spatial characteristics associated with the plurality of dots when the plurality of dots are projected onto the material surface using a calibrated defect detection system. A defect detection and quality control system may be calibrated when the defect imaging unit 400 is provided in a position and/or an orientation that enables the defect imaging unit 400 to detect one or more defects in the material surface 110 or determine a quality of a material with a predetermined level of accuracy and/or a predetermined level of precision. In some cases, the defect detection and quality control system may be calibrated when the material fabrication or processing machine is provided in a position and/or an orientation that enables the defect imaging unit 400 to detect one or more defects in the material surface 110 or determine a quality of a material with a predetermined level of accuracy and/or a predetermined level of precision. In other cases, the defect detection and quality control system may be calibrated when the material surface 110 is provided at an angle or an inclination relative to the defect imaging unit 400 that enables the defect imaging unit 400 to detect one or more defects in the material surface 110 or determine a quality of a material with a predetermined level of accuracy and/or a predetermined level of precision. Alternatively, the defect detection and quality control system may be calibrated when an imaging parameter of the defect detection and quality control system is adjusted to enable the defect detection and quality control system to detect defects or determine a quality of a material with a predetermined level of accuracy and/or a predetermined level of precision. In some cases, the defect detection and quality control system may be calibrated when a lighting parameter of the defect detection and quality control system is adjusted to enable the defect detection and quality control system to detect defects or determine a quality of a material with a predetermined level of accuracy and/or a predetermined level of precision. The predetermined level of accuracy and/or the predetermined level of precision may correspond to a level of accuracy or a level of precision that allows the defect detection and quality control system to detect defects or determine a quality of a material with a false positive rate or a false negative rate that is under a predetermined threshold value. A false positive rate may correspond to a rate or a frequency at which the defect detection and quality control system (i) falsely determines a presence of a defect in the material surface or (ii) falsely determines that a material is of substandard quality. A false negative rate may correspond to a rate or a frequency at which the defect detection and quality control system (i) falsely determines that a defect is not present in the material surface or (ii) falsely determines that a material is not of substandard quality.

In some cases, the one or more calibration features may comprise one or more one-dimensional (1-D) features. The one or more one-dimensional (1-D) features may comprise one or more lines.

The one or more lines may have one or more lengths. The one or more lengths may be the same. For example, each of the one or more lines may have a same length. In some cases, the one or more lengths may be different. For example, each of the one or more lines may have a different length. In some cases, at least one of the one or more lines may have a length that is different than the one or more lengths of the other lines. The one or more lengths may be at least about 1 millimeter (mm), 2 mm, 3 mm, 4 mm, 5 mm, 6 mm, 7 mm, 8 mm, 9 mm, 1 centimeter (cm), 2 cm, 3 cm, 4 cm, 5 cm, 6 cm, 7 cm, 8 cm, 9 cm, 10 cm, 20 cm, 30 cm, 40 cm, 50 cm, 60 cm, 70 cm, 80 cm, 90 cm, 1 meter (m), 2 m, 3 m, 4 m, 5 m, 6 m, 7 m, 8 m, 9 m, 10 m, or more.

The one or more lines may be separated by a separation distance. The separation distance may correspond to a distance between an endpoint of a first line and an endpoint of a second line. In some cases, the separation distance may correspond to a distance between a portion of a first line and a portion of a second line. The separation distance may be at least about 1 millimeter (mm), 2 mm, 3 mm, 4 mm, 5 mm, 6 mm, 7 mm, 8 mm, 9 mm, 1 centimeter (cm), 2 cm, 3 cm, 4 cm, 5 cm, 6 cm, 7 cm, 8 cm, 9 cm, 10 cm, 20 cm, 30 cm, 40 cm, 50 cm, 60 cm, 70 cm, 80 cm, 90 cm, 1 meter (m), 2 m, 3 m, 4 m, 5 m, 6 m, 7 m, 8 m, 9 m, 10 m, or more.

In some cases, at least one of the one or more lines may be substantially straight or linear. In other cases, at least one of the one or more lines may be substantially non-linear. In some cases, at least one of the one or more lines may comprise a curved portion. In some cases, at least one of the one or more lines may comprise an angled portion. The angled portion may form an angle between a first linear portion and a second linear portion. The angle may range from 0° to 360°.

In some cases, at least one of the one or more lines may comprise a solid line. Alternatively, at least one of the one or more lines may comprise a broken line comprising two or more line segments. The two or more line segments may be separated from each other by a separation distance.

In some cases, at least two of the lines may be parallel to each other. In some cases, at least two of the lines may be non-parallel to each other. In some cases, at least two of the lines may be perpendicular to each other. In some cases, at least two of the lines may be non-perpendicular to each other. In some cases, at least two of the lines may be oriented at an oblique angle relative to each other. In some cases, at least two of the lines may intersect with each other. In such cases, the two lines may form an intersection angle. The intersection angle may range from 0° to 360°. In some cases, the intersection angle may be about 0°, 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29°, 30°, 31°, 32°, 33°, 34°, 35°, 36°, 37°, 38°, 39°, 40°, 41°, 42°, 43°, 44°, 45°, 46°, 47°, 48°, 49°, 50°, 51°, 52°, 53°, 54°, 55°, 56°, 57°, 58°, 59°, 60°, 61°, 62°, 63°, 64°, 65°, 66°, 67°, 68°, 69°, 70°, 71°, 72°, 73°, 74°, 75°, 76°, 77°, 78°, 79°, 80°, 81°, 82°, 83°, 84°, 85°, 86°, 87°, 88°, 89°, 90°, 95°, 100°, 105°, 110°, 115°, 120°, 125°, 130°, 135°, 140°, 145°, 150°, 155°, 160°, 165°, 170°, 175°, 180°, 190°, 200°, 210°, 220°, 230°, 240°, 250°, 260°, 270°, 280°, 290°, 300°, 310°, 320°, 330°, 340°, 350°, or 360°. In some cases, at least two of the lines may not intersect with each other.

In some cases, at least two of the lines may overlap with each other. In some cases, at least two of the lines may coincide with each other. In some cases, at least a portion of at least two of the lines may coincide and/or overlap with each other. In other cases, at least two of the lines may be configured to converge at one or more points.

In some cases, at least one of the one or more lines may extend along a vertical axis when projected onto the material surface. In other cases, at least one of the one or more lines may extend along a horizontal axis when projected onto the material surface.

In some cases, at least one of the one or more lines may extend at an angle when projected onto the material surface. The angle may be range from between about 0°, to about 360°.

In some cases, the one or more lines may be configured to form a grid. The grid may comprise a plurality of intersecting lines. The plurality of intersecting lines may comprise a plurality of parallel lines and a plurality of perpendicular lines. The plurality of intersecting lines may comprise a plurality of non-parallel lines and/or a plurality of non-perpendicular lines. In such cases, the plurality of intersecting lines may be configured to intersect with each other at one or more intersection angles. The one or more intersection angles may be the same. The one or more intersection angles may be different. The one or more intersection angles may be about 0°, 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29°, 30°, 31°, 32°, 33°, 34°, 35°, 36°, 37°, 38°, 39°, 40°, 41°, 42°, 43°, 44°, 45°, 46°, 47°, 48°, 49°, 50°, 51°, 52°, 53°, 54°, 55°, 56°, 57°, 58°, 59°, 60°, 61°, 62°, 63°, 64°, 65°, 66°, 67°, 68°, 69°, 70°, 71°, 72°, 73°, 74°, 75°, 76°, 77°, 78°, 79°, 80°, 81°, 82°, 83°, 84°, 85°, 86°, 87°, 88°, 89°, 90°, 95°, 100°, 105°, 110°, 115°, 120°, 125°, 130°, 135°, 140°, 145°, 150°, 155°, 160°, 165°, 170°, 175°, 180°, 190°, 200°, 210°, 220°, 230°, 240°, 250°, 260°, 270°, 280°, 290°, 300°, 310°, 320°, 330°, 340°, 350°, or 360°.

In some cases, the one or more calibration features may comprise one or more edge markers. The one or more edge markers may be projected at or near one or more corners or edges of the material surface. The one or more edge markers may comprise one or more sets of perpendicular lines. In some cases, the one or more edge markers may comprise one or more sets of intersecting lines that are not perpendicular. In other cases, the one or more edge markers may comprise one or more sets of non-intersecting lines.

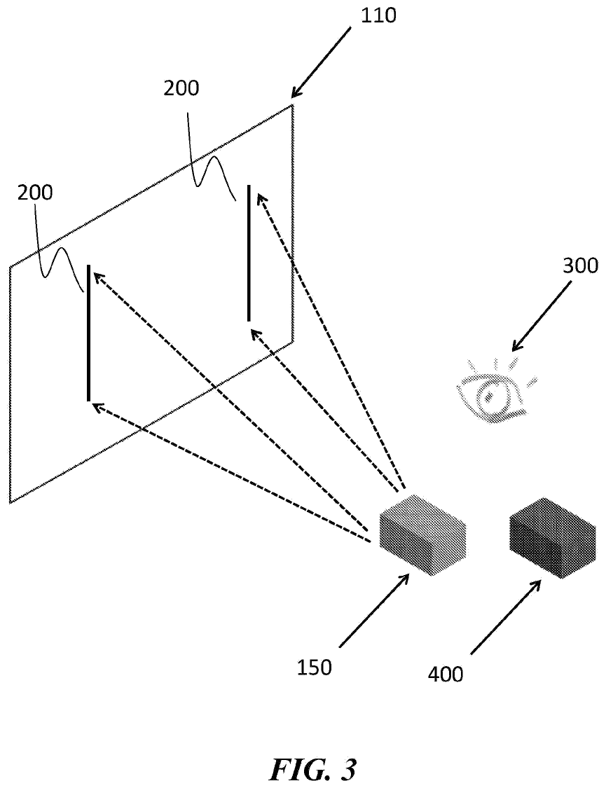

FIG. 3 illustrates a material surface 110 onto which a projection unit 150 may optically project one or more calibration features 200. The projection unit 150 may comprise one or more light sources as described herein. The one or more light sources may comprise one or more laser light sources. The one or more calibration features 200 may comprise one or more lines. The one or more lines may be configured to appear as parallel lines on the material surface if and/or when the one or more lines are projected onto the material surface using a calibrated defect detection system. In any of the embodiments described herein, the one or more calibration features 200 may comprise one or more intentionally created defects. The one or more intentionally created defects may be directly integrated into the material surface 110 or a portion thereof. In some cases, a calibration analysis unit 300 may be configured to obtain and/or capture one or more images of the material surface 110 with the one or more lines 200 optically projected onto the material surface 110. The calibration analysis unit 300 may comprise one or more image capture devices (e.g., one or more cameras). In some cases, the calibration analysis unit 300 may be configured to implement an image processing algorithm to process the one or more images of the material surface 110 to determine one or more spatial characteristics of the one or more lines based at least in part on the optical projection of the one or more lines. The one or more spatial characteristics may comprise one or more of the following: (i) a distance between two or more lines, (ii) a relative position of the one or more lines, (iii) a relative orientation of the one or more lines, (iv) a relative alignment of the one or more lines in relation to one another, (v) a size (e.g., a length, a width, a height, and/or a thickness) of the one or more lines, or (vi) a shape of the one or more lines. In some cases, a human operator (e.g., an operator of a material fabrication or processing machine) may visually determine the one or more spatial characteristics associated with the one or more lines projected onto the material surface 110. In some cases, the calibration analysis unit 300 may be configured to implement a quality control algorithm as described elsewhere herein.

In some embodiments, the one or more spatial characteristics may be usable to adjust a position and/or an orientation of a defect imaging unit 400. For example, the one or more spatial characteristics may be usable to adjust a position and/or an orientation of a defect imaging unit 400 relative to the material surface 110. In another example, the one or more spatial characteristics may be usable to adjust a position and/or an orientation of a defect imaging unit 400 relative to a material fabrication or processing machine used to fabricate and/or process the material surface 110. In another example, the one or more spatial characteristics may be usable to adjust an angle or an inclination of the material surface 110 relative to the defect imaging unit 400. In another example, the one or more spatial characteristics may be usable to adjust an imaging parameter associated with the defect detection and quality control system or a component of the defect detection and quality control system (e.g., a defect imaging unit). The imaging parameter may comprise an exposure time, a shutter speed, an aperture, a film speed, a field of view, an area of focus, a focus distance, a capture rate, or a capture time associated with the defect imaging unit. In another example, the one or more spatial characteristics may be usable to adjust a lighting parameter associated with the defect detection and quality control system or a component of the defect detection and quality control system (e.g., a defect imaging unit).

In some cases, the calibration analysis unit 300 may determine that the defect detection and quality control system is calibrated when the one or more lines appear parallel to each other. In some cases, the calibration analysis unit 300 may determine that the defect detection system is calibrated when a first set of spatial characteristics associated with the one or more lines corresponds to a second set of spatial characteristics associated with a plurality of reference features projected onto a reference image. The plurality of reference features may comprise a plurality of reference lines. The plurality of reference lines may have a set of reference spatial characteristics (e.g., parallelism) that are produced when the plurality of lines are projected onto a material surface using a calibrated defect detection system.

The defect detection and quality control system may be calibrated when one or more components of the defect detection system (e.g., the defect imaging unit 400) is provided in a position and/or an orientation that enables the defect imaging unit 400 to detect one or more defects in the material surface 110 or determine a quality of a material with a predetermined level of accuracy and/or a predetermined level of precision. In some cases, the defect detection and quality control system may be calibrated when the material surface 110 is provided at an angle or an inclination relative to the defect imaging unit 400 that enables the defect imaging unit 400 to detect one or more defects in the material surface 110 or determine a quality of a material with a predetermined level of accuracy and/or a predetermined level of precision. Alternatively, the defect detection and quality control system may be calibrated when an imaging parameter of the defect detection and quality control system is adjusted to enable the defect detection and quality control system to detect defects or determine a quality of a material with a predetermined level of accuracy and/or a predetermined level of precision. In some cases, the defect detection and quality control system may be calibrated when a lighting parameter of the defect detection and quality control system is adjusted to enable the defect detection and quality control system to detect defects or determine a quality of a material with a predetermined level of accuracy and/or a predetermined level of precision. A predetermined level of accuracy may correspond to an accuracy with which the defect imaging unit 400 may determine a quality of a material or detect one or more defects within a material surface or within a plurality of material surfaces over time. The predetermined level of accuracy may correspond to a rate at which the defect imaging unit 400 correctly determines a quality of a material or detects and/or classifies one or more defects. The predetermined level of accuracy may be at least about 10%, 20%, 30%, 40%, 50%, 60%, 70%, 80%, 90%, 95%, 99%, or more. The predetermined level of accuracy may be at most about 99%, 95%, 90%, 80%, 70%, 60%, 50%, 40%, 30%, 20%, 10%, or less. A predetermined level of precision may correspond to a level of consistency at which the defect imaging unit 400 determines a quality of a material relative to a desired or predetermined quality control standard or benchmark, or detects and/or classifies one or more defects within a material surface, or across one or more material surfaces over time. The predetermined level of precision may correspond to a standard deviation associated with an average value of the one or more rates at which the defect imaging unit 400 correctly determines a quality of a material or detects and/or classifies one or more defects. The standard deviation may be at least about 1 standard deviation, 2 standard deviations, 3 standard deviations, or more. The standard deviation may be at most about 3 standard deviations, 2 standard deviations, 1 standard deviation, or less. In some cases, the defect detection system may be calibrated when the material fabrication or processing machine is provided in a position and/or an orientation that enables the defect imaging unit 400 to detect one or more defects in the material surface 110 at the predetermined level of accuracy and/or a predetermined level of precision. In other cases, the defect detection system may be calibrated when the material surface 110 is provided at an angle or an inclination relative to the defect imaging unit 400 that enables the defect imaging unit 400 to detect one or more defects in the material surface 110 at the predetermined level of accuracy and/or a predetermined level of precision. Alternatively, the defect detection and quality control system may be calibrated when an imaging parameter of the defect detection and quality control system is adjusted to enable the defect detection and quality control system to detect defects or determine a quality of a material with a predetermined level of accuracy and/or a predetermined level of precision. In some cases, the defect detection and quality control system may be calibrated when a lighting parameter of the defect detection and quality control system is adjusted to enable the defect detection and quality control system to detect defects or determine a quality of a material with a predetermined level of accuracy and/or a predetermined level of precision.

As described above, in some cases the predetermined level of accuracy and/or the predetermined level of precision may correspond to a level of accuracy or a level of precision that allows the defect detection and quality control system to detect defects or determine a quality of a material with a false positive rate or a false negative rate that is under a predetermined threshold value. A false positive rate may correspond to a rate or a frequency at which the defect detection system (i) falsely determines a presence of a defect in the material surface or (ii) falsely determines that a material is of substandard quality. A false negative rate may correspond to a rate or a frequency at which the defect detection and quality control system (i) falsely determines that a defect is not present in the material surface or (ii) falsely determines that a material is not of substandard quality. A defect detection and quality control system may be calibrated when the defect detection system is able to determine a quality of a material or detect one or more defects with a false positive rate or a false negative rate that is under a predetermined threshold value. In some cases, the defect detection and quality control system may be calibrated when the defect imaging unit is provided in a position and/or an orientation relative to the material surface or the material fabrication or processing machine such that the defect detection and quality control system is able to determine a quality of a material or detect defects with a false positive rate or a false negative rate that is under a predetermined threshold value.

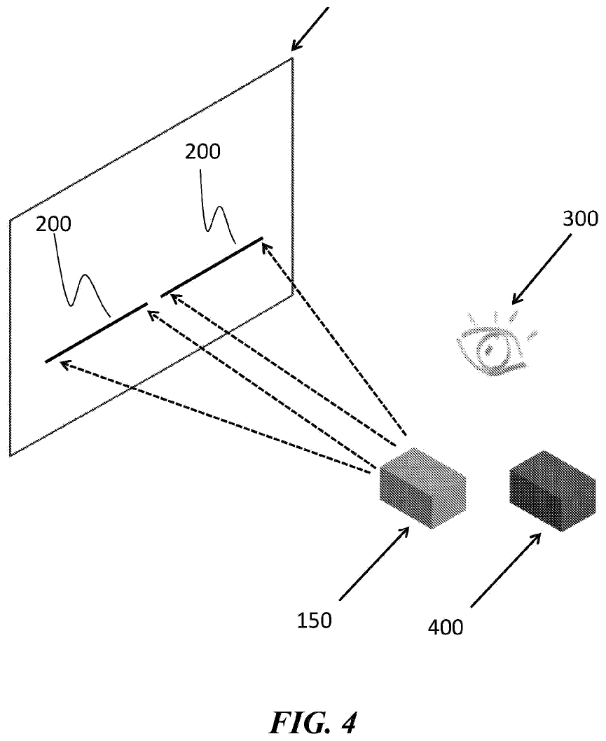

FIG. 4 illustrates a material surface 110 onto which a projection unit 150 may optically project one or more calibration features 200. The projection unit 150 may comprise one or more light sources as described herein. The one or more light sources may comprise one or more laser light sources. The one or more calibration features 200 may comprise one or more lines. The one or more lines may be configured to appear as collinear lines (i.e., the one or more lines may appear to coincide with and/or lie along a same reference line that extends across a portion of the material surface) on the material surface if and/or when the one or more lines are projected onto a material surface using a calibrated defect detection system. In some cases, a calibration analysis unit 300 may be configured to obtain and/or capture one or more images of the material surface 110 with the one or more lines 200 optically projected onto the material surface 110. In some cases, the calibration analysis unit 300 may be configured to implement an image processing algorithm to process the one or more images of the material surface 110 to determine one or more spatial characteristics of the one or more lines based at least in part on the optical projection of the one or more lines. The one or more spatial characteristics may comprise one or more of the following: (i) a distance between two or more lines, (ii) a relative position of the one or more lines, (iii) a relative orientation of the one or more lines, (iv) a relative alignment of the one or more lines in relation to one another, (v) a size (e.g., a length, a width, a height, and/or a thickness) of the one or more lines, or (vi) a shape of the one or more lines. In some cases, a human operator (e.g., an operator of a material fabrication or processing machine) may visually determine the one or more spatial characteristics associated with the one or more lines projected onto the material surface 110.

In some embodiments, the one or more spatial characteristics may be usable to adjust a position and/or an orientation of a defect imaging unit 400. For example, the one or more spatial characteristics may be usable to adjust a position and/or an orientation of a defect imaging unit 400 relative to the material surface 110. In another example, the one or more spatial characteristics may be usable to adjust a position and/or an orientation of a defect imaging unit 400 relative to a material fabrication or processing machine used to fabricate and/or process the material surface 110. In another example, the one or more spatial characteristics may be usable to adjust an angle or an inclination of the material surface 110 relative to the defect imaging unit 400. In another example, the one or more spatial characteristics may be usable to adjust one or more imaging parameters associated with the defect detection and quality control system or a component of the defect detection and quality control system (e.g., a defect imaging unit). The one or more imaging parameters may comprise an exposure time, a shutter speed, an aperture, a film speed, a field of view, an area of focus, a focus distance, a capture rate, or a capture time associated with the defect imaging unit. In another example, the one or more spatial characteristics may be usable to adjust one or more lighting parameters associated with the defect detection and quality control system or a component of the defect detection and quality control system (e.g., a defect imaging unit).

In some cases, the calibration analysis unit 300 may determine that the defect detection and quality control system is calibrated when the one or more lines are collinear with each other. In some cases, the calibration analysis unit 300 may determine that the defect detection and quality control system is calibrated when a first set of spatial characteristics associated with the one or more lines corresponds to a second set of spatial characteristics associated with a plurality of reference features projected onto a reference image. The plurality of reference features may comprise a plurality of reference lines. The plurality of reference lines may have a set of reference spatial characteristics (e.g., collinearity) that correspond to a set of spatial characteristics associated with the plurality of lines when the plurality of lines are projected onto the material surface using a calibrated defect detection system.

The defect detection and quality control system may be calibrated when the defect imaging unit 400 is provided in a position and/or an orientation that enables the defect imaging unit 400 to determine a quality of a material or detect one or more defects in the material surface 110 at a predetermined level of accuracy and/or a predetermined level of precision. In some cases, the defect detection and quality control system may be calibrated when the material fabrication or processing machine is provided in a position and/or an orientation that enables the defect imaging unit 400 to determine a quality of a material or detect one or more defects in the material surface 110 at the predetermined level of accuracy and/or a predetermined level of precision. In other cases, the defect detection and quality control system may be calibrated when the material surface 110 is provided at an angle or an inclination relative to the defect imaging unit 400 that enables the defect imaging unit 400 to determine a quality of a material or detect one or more defects in the material surface 110 at the predetermined level of accuracy and/or a predetermined level of precision. Alternatively, the defect detection and quality control system may be calibrated when an imaging parameter of the defect detection and quality control system is adjusted to enable the defect detection and quality control system to detect defects or determine a quality of a material with a predetermined level of accuracy and/or a predetermined level of precision. In some cases, the defect detection and quality control system may be calibrated when a lighting parameter of the defect detection and quality control system is adjusted to enable the defect detection and quality control system to detect defects or determine a quality of a material with a predetermined level of accuracy and/or a predetermined level of precision.

In some embodiments, the one or more calibration features may comprise one or more two-dimensional (2D) features. The one or more two-dimensional (2D) features may comprise one or more shapes.

In some cases, at least one of the one or more shapes may be a regular shape or a portion thereof. The regular shape may comprise a circle, an ellipse, or a polygon. In some cases, the polygon may comprise an n-sided polygon, wherein n is greater than three. In some cases, each side of the polygon may be a same length. In other cases, one or more sides of the polygon may have a different length than one or more other sides of the polygon. In some cases, at least one of the shapes may comprise an irregular or amorphous shape. An irregular shape may comprise a shape with a plurality of sides having one or more different lengths. An amorphous shape may comprise a shape that does not correspond to a circle, an ellipse, or a polygon.

In some cases, at least two of the shapes may be provided separately without overlapping with each other. In other cases, at least a portion of two or more shapes may overlap with each other.

In some cases, at least two of the shapes may lie along a common horizontal axis. In such cases, the respective centers of each of the shapes may lie along the common horizontal axis. In other cases, at least two of the shapes may lie along a common vertical axis. In such cases, the respective centers of each of the shapes may lie along the common vertical axis. In some cases, at least two of the shapes may lie along a common axis that extends at an angle relative to a reference point located on the material surface. The angle may range from between about 0° to about 360°.

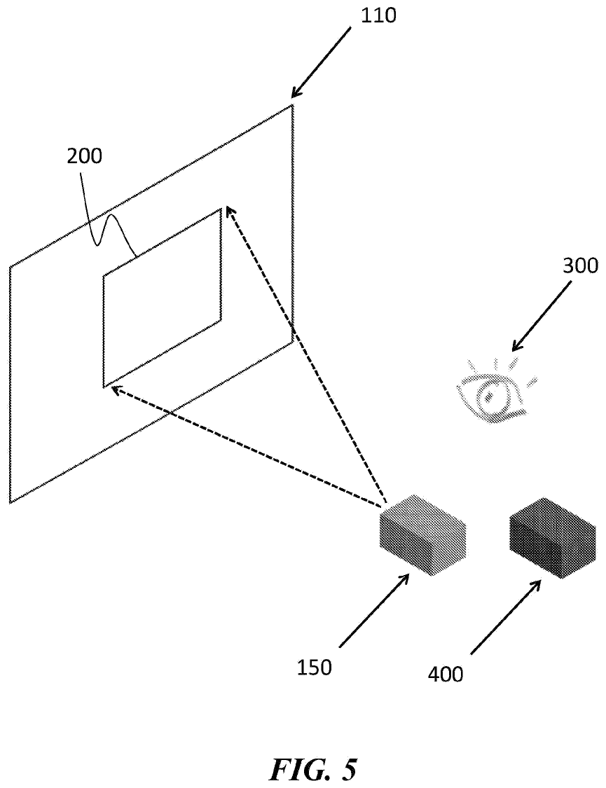

FIG. 5 illustrates a material surface 110 onto which a projection unit 150 may optically project one or more calibration features 200. The projection unit 150 may comprise one or more light sources as described herein. The one or more light sources may comprise one or more laser light sources. The one or more calibration features 200 may comprise one or more shapes. The one or more shapes may be configured to appear as an undistorted shape on the material surface if and/or when a calibrated defect detection system is used to project the one or more shapes onto the material surface. An undistorted shape may correspond to a shape that appears on a substantially flat material surface when a calibrated defect detection system is used to project the shape onto the substantially flat material surface. In any of the embodiments described herein, the one or more calibration features 200 may comprise one or more intentionally created defects. The one or more intentionally created defects may be directly integrated into the material surface 110 or a portion thereof.

In some cases, a calibration analysis unit 300 may be configured to obtain and/or capture one or more images of the material surface 110 with the one or more shapes 200 optically projected onto the material surface 110. In some cases, the calibration analysis unit 300 may be configured to implement an image processing algorithm to process the one or more images of the material surface 110 to determine one or more spatial characteristics of the one or more shapes based at least in part on the optical projection of the one or more lines. The one or more spatial characteristics may comprise one or more of the following: (i) a distance between two or more portions of the one or more shapes, (ii) a relative position of the one or more shapes, (iii) a relative orientation of the one or more shapes, (iv) a relative alignment of the one or more shapes in relation to one another, (v) a size (e.g., a length, a width, a height, and/or a thickness) of the one or more shapes, or (vi) a shape of the one or more shapes. In some cases, a human operator (e.g., an operator of a material fabrication or processing machine) may visually determine one or more spatial characteristics associated with the one or more shapes projected onto the material surface 110. In some cases, the calibration analysis unit 300 may be configured to implement a quality control algorithm as described elsewhere herein.

In some embodiments, the one or more spatial characteristics may be usable to adjust a position and/or an orientation of a defect imaging unit 400. For example, the one or more spatial characteristics may be usable to adjust a position and/or an orientation of a defect imaging unit 400 relative to the material surface 110. In another example, the one or more spatial characteristics may be usable to adjust a position and/or an orientation of a defect imaging unit 400 relative to a material fabrication or processing machine used to fabricate and/or process the material surface 110. In another example, the one or more spatial characteristics may be usable to adjust an angle or an inclination of the material surface 110 relative to the defect imaging unit 400. In another example, the one or more spatial characteristics may be usable to adjust an imaging parameter associated with the defect detection and quality control system or a component of the defect detection and quality control system (e.g., a defect imaging unit). In another example, the one or more spatial characteristics may be usable to adjust a lighting parameter associated with the defect detection and quality control system or a component of the defect detection and quality control system (e.g., a defect imaging unit).

In some cases, the calibration analysis unit 300 may determine that the defect detection system is calibrated when the one or more shapes appear undistorted. The one or more shapes may appear undistorted if the one or more shapes have a first set of spatial characteristics (e.g., size, shape, position, and/or orientation) that correspond to a second set of spatial characteristics associated with a plurality of reference features projected onto a reference image. The plurality of reference features may comprise a plurality of reference shapes. The plurality of reference shapes may have a set of reference spatial characteristics (e.g., size, shape, position, and/or orientation) that correspond to a set of spatial characteristics associated with the one or more shapes when the one or more shapes are projected onto the material surface using a calibrated defect detection system.

The defect detection system may be calibrated when the defect imaging unit 400 is provided in a position and/or an orientation that enables the defect imaging unit 400 to determine a quality of a material or detect one or more defects in the material surface 110 at a predetermined level of accuracy and/or a predetermined level of precision. In some cases, the defect detection and quality control system may be calibrated when the material fabrication or processing machine is provided in a position and/or an orientation that enables the defect imaging unit 400 to determine a quality of a material or detect one or more defects in the material surface 110 at the predetermined level of accuracy and/or a predetermined level of precision. In other cases, the defect detection and quality control system may be calibrated when the material surface 110 is provided at an angle or an inclination relative to the defect imaging unit 400 that enables the defect imaging unit 400 to determine a quality of a material or detect one or more defects in the material surface 110 at the predetermined level of accuracy and/or a predetermined level of precision. Alternatively, the defect detection and quality control system may be calibrated when an imaging parameter of the defect detection and quality control system is adjusted to enable the defect detection and quality control system to detect defects or determine a quality of a material with a predetermined level of accuracy and/or a predetermined level of precision. In some cases, the defect detection and quality control system may be calibrated when a lighting parameter of the defect detection and quality control system is adjusted to enable the defect detection and quality control system to detect defects or determine a quality of a material with a predetermined level of accuracy and/or a predetermined level of precision.

In some embodiments, the one or more calibration features may comprise one or more three-dimensional (3D) features. In some cases, the one or more three-dimensional (3D) features comprises one or more holographic features. The one or more holographic features may comprise a virtual three-dimensional image. The virtual three-dimensional image may comprise a three-dimensional object or a portion thereof. In some cases, the three-dimensional object may comprise a sphere, an ellipsoid, a cylinder, a cube, a cuboid, a rectangular prism, a cone, a hexagonal prism, a square pyramid, a triangular pyramid, a hexagonal pyramid, a triangular prism, a tetrahedron, an octahedron, a dodecahedron, or an icosahedron. As described above, the calibration analysis unit may determine that the defect detection system is calibrated based on a comparison of (i) a first set of spatial characteristics (e.g., size, shape, position, and/or orientation) associated with the one or more three-dimensional features and (ii) a second set of spatial characteristics associated with a plurality of reference three-dimensional features displayed and/or projected within a reference image. In any of the embodiments described herein, the one or more calibration features may comprise one or more intentionally created defects. The one or more intentionally created defects may be directly integrated into the material surface or a portion thereof.

In some cases, the one or more calibration features may comprise one or more calibration images. The one or more calibration images may be selected from the group consisting of barcodes and/or quick response (QR) codes. Barcodes may define a version, a format, a type, a position, an alignment, a timing, or any other characteristic or parameter associated with calibration that may be determined after scanning or decoding of the barcode. QR codes may comprise two-dimensional barcodes that use dark and light modules arranged in a shape (e.g., a square) to encode data such that the data may be optically captured, processed, and read by a machine. Various types of information can be encoded in barcodes or QR codes in any type of suitable format, such as binary, alphanumeric, etc. A QR code can be based on any number of standards. A QR code can have various symbol sizes, as long as the QR code can be scanned or imaged by an imaging unit or machine reader. A QR code can be of any image format (e.g. EPS or SVG vector graphs, PNG, GIF, or JPEG raster graphics format). In some embodiments, a QR code may conform to known standards that can be read by standard QR readers. The information encoded by a QR code may be made up of four standardized types (“modes”) of data (numeric, alphanumeric, byte/binary, kanji) or, through supported extensions, virtually any type of data. In some embodiments, the QR code may be proprietary such that it can be read only by the calibration system disclosed herein.

In some cases, the one or more calibration features may comprise one or more calibration features that are not projected onto the material surface. In such cases, the one or more calibration features may comprise a calibration tool or a calibration device that may be affixed to the material surface or a portion thereof. The calibration tool or calibration device may have a size, a shape, a position, an orientation, and/or one or more spatial characteristics that may be used to aid in calibration of any of the defect detection and quality control systems described herein. In some cases, the calibration tool or calibration device may comprise a sticker that may be affixed or attached to the material surface using an adhesive material. In other cases, the calibration tool or calibration device may comprise a physical object that is releasably attached or coupled to at least a portion of the material surface to aid in calibration. In one non-limiting example, the physical object may be coupled to the material surface using a pin, a clamp, a clip, a hook, a magnet, or an adhesive material.

In some cases, the one or more calibration features may comprise one or more defects, patterns, or features produced intentionally or on purpose on or within the material surface. The one or more intentionally created defects may be directly integrated into the material surface or a portion thereof. In some cases, the one or more intentional defects, patterns, or features may be produced by adding one or more strings, threads, or yarns comprising a different color, dimension, or material into the material surface during the manufacturing or processing of the material surface. In some cases, the one or more intentional defects, patterns, or features may be produced by adding or removing one or more strings, threads, or yarns to or from the material surface during the manufacturing or processing of the material surface. The addition or removal of one or more strings, threads, or yarns to or from the material surface may produce one or more lines, patterns, gaps, or features within the material surface. The one or more lines, patterns, gaps, or features may correspond to intentional defects that are usable for calibration or quality control. Any of the defect detection and quality control systems of the present disclosure may be used to identify the one or more intentional defects, determine one or more spatial characteristics or properties of the intentional defects (e.g., a relative size, a relative shape, a position, and/or an orientation of the intentional defects in relation to one or more portions of the material surface), and calibrate one or more components of the defect detection and quality control systems described herein, based at least in part on the one or more spatial characteristics or properties of the intentional defects. As described elsewhere herein, calibration may involve adjusting at least one of (i) a position or an orientation of the defect detection and quality control system relative to the material surface or relative to the material fabrication or processing machine, (ii) an angle or an inclination of the material surface relative to the defect detection and quality control system, (iii) one or more imaging parameters of the defect detection and quality control system, or (iv) one or more lighting parameters of the defect detection and quality control system.

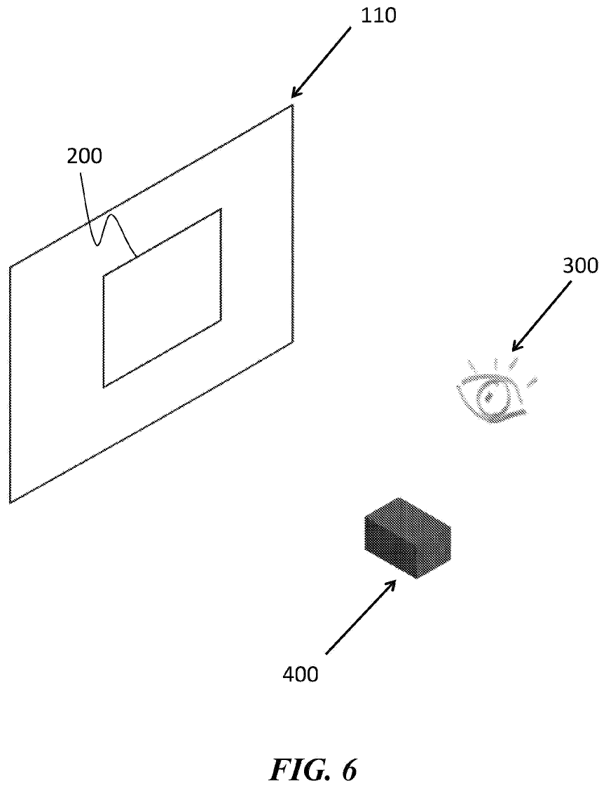

FIG. 6 illustrates a material surface 110 comprising one or more calibration features 200. The one or more calibration features 200 may comprise one or more shapes or images that are not projected onto the material surface 110. The one or more shapes or images may comprise a barcode and/or a quick response (QR) code. In some cases, a calibration analysis unit 300 may be configured to obtain and/or capture one or more images of the material surface 110 with the one or more calibration features 200 optically projected onto the material surface 110. In some cases, the calibration analysis unit 300 may be configured to implement an image processing algorithm to process the one or more images of the material surface 110 to determine one or more properties or spatial characteristics of the one or more calibration features. The one or more properties or spatial characteristics may comprise one or more of the following: (i) a distance between two or more portions of the barcode and/or quick response (QR) code, (ii) a relative position of the barcode and/or quick response (QR) code, (iii) a relative orientation of the barcode and/or quick response (QR) code, (iv) a relative alignment of two or more portions of the barcode and/or quick response (QR) code in relation to one another, (v) a size (e.g., a length, a width, a height, and/or a thickness) of the barcode and/or quick response (QR) code, or (vi) a shape of the barcode and/or quick response (QR) code. In some cases, a human operator (e.g., an operator of a material fabrication or processing machine) may visually determine the one or more spatial characteristics associated with the barcode and/or quick response (QR) code provided on the material surface 110.

In some embodiments, the one or more properties or spatial characteristics of the barcode and/or quick response (QR) code may be usable to adjust a position and/or an orientation of a defect imaging unit 400. For example, the one or more spatial characteristics may be usable to adjust a position and/or an orientation of a defect imaging unit 400 relative to the material surface 110. In another example, the one or more spatial characteristics may be usable to adjust a position and/or an orientation of a defect imaging unit 400 relative to a material fabrication or processing machine used to fabricate and/or process the material surface 110. In another example, the one or more spatial characteristics may be usable to adjust an angle or an inclination of the material surface 110 relative to the defect imaging unit 400. In another example, the one or more spatial characteristics may be usable to adjust one or more imaging parameters of the defect imaging unit 400. In another example, the one or more spatial characteristics may be usable to adjust one or more lighting parameters of the defect imaging unit 400.

In some cases, the calibration analysis unit 300 may determine that the defect detection system is calibrated when the barcode and/or quick response (QR) code appears undistorted. The barcode and/or quick response (QR) code may appear undistorted if the barcode and/or quick response (QR) code has a first set of spatial characteristics (e.g., size, shape, position, and/or orientation) that corresponds to a second set of spatial characteristics associated with a plurality of reference features projected onto or displayed within a reference image. The plurality of reference features may comprise a plurality of reference barcodes and/or quick response (QR) codes. The plurality of reference barcodes and/or quick response (QR) codes may have a set of reference spatial characteristics (e.g., size, shape, position, and/or orientation) that may be obtained and/or observable when a reference barcode and/or a reference quick response (QR) code is provided on a material surface (e.g., a substantially flat material surface) with a set of known spatial properties.

The defect detection and quality control system may be calibrated when the defect imaging unit 400 is provided in a position and/or an orientation that enables the defect imaging unit 400 to detect one or more defects in the material surface 110 at a predetermined level of accuracy and/or a predetermined level of precision. In some cases, the defect detection and quality control system may be calibrated when the material fabrication or processing machine is provided in a position and/or an orientation that enables the defect imaging unit 400 to detect one or more defects in the material surface 110 at the predetermined level of accuracy and/or a predetermined level of precision. In other cases, the defect detection and quality control system may be calibrated when the material surface 110 is provided at an angle or an inclination relative to the defect imaging unit 400 that enables the defect imaging unit 400 to detect one or more defects in the material surface 110 at the predetermined level of accuracy and/or a predetermined level of precision. Alternatively, the defect detection and quality control system may be calibrated when an imaging parameter of the defect detection and quality control system is adjusted to enable the defect detection and quality control system to detect defects or determine a quality of a material with a predetermined level of accuracy and/or a predetermined level of precision. In some cases, the defect detection and quality control system may be calibrated when a lighting parameter of the defect detection and quality control system is adjusted to enable the defect detection and quality control system to detect defects or determine a quality of a material with a predetermined level of accuracy and/or a predetermined level of precision.

In some cases, at least one of the one or more calibration features may be projected at or near a central region of the material surface. In other cases, at least one of the one or more calibration features may be projected at or near one or more corners or edges of the material surface. Alternatively, at least one of the one or more calibration features may be projected onto any portion or section of the material surface.

In some cases, the one or more calibration features may be projected such that the one or more calibration features cover at least a portion of a dimension or an area of the material surface. The at least a portion of a dimension of the material surface may be at least about 10%, 20%, 30%, 40%, 50%, 60%, 70%, 80%, 90%, or more of a length, a width, and/or a height of the material surface. The at least a portion of an area of the material surface may be at least about 10%, 20%, 30%, 40%, 50%, 60%, 70%, 80%, 90%, or more of an area of the material surface.

As described above, the optical projection of the one or more calibration features may be generated using one or more laser sources. The one or more laser sources may be configured to project one or more laser dots as described above. In some cases, the one or more laser sources may comprise one or more line lasers. In other cases, the one or more laser sources may comprise one or more cross lasers.

The one or more laser sources may be used to aid in a mechanical calibration of a position and/or an orientation of the defect imaging device relative to the material surface or the material fabrication or processing machine. In some cases, the one or more laser sources may be used to calibrate a position and/or an orientation of the one or more laser sources relative to the material surface or the material fabrication or processing machine. In some cases, the one or more laser sources may be used to calibrate a position and/or an orientation of a camera relative to the material surface, the material fabrication or processing machine, or the one or more laser sources. The camera may be configured to capture one or more images of the material surface. In some cases, the camera may be configured to capture one or more images of one or more calibration features that are projected onto the material surface using the one or more laser sources. The one or more images captured by the camera may be used to aid in a mechanical calibration of a position and/or an orientation of the defect imaging device relative to the material surface or the material fabrication or processing machine. The one or more images captured by the camera may be used to aid in a mechanical calibration of a position and/or an orientation of the one or more laser sources relative to the material surface or the material fabrication or processing machine.

In some cases, the one or more laser sources may comprise one or more line lasers. The one or more line lasers may be configured to project at least one or more one-dimensional calibration features onto a portion of the material surface. The one or more one-dimensional calibration features may comprise one or more lines or line segments. The one or more lines or line segments may comprise a horizontal line when projected onto a substantially flat material surface using a calibrated defect detection system. The one or more lines or line segments may comprise a center point.

In some cases, the one or more line lasers may be configured to operate at a working voltage that ranges from about 3.3 volts to about 5 volts. In some cases, the one or more line lasers may be configured to operate at around 3.7 volts. In some cases, the one or more line lasers may be configured to operate at a load operating current that ranges from about 16 milliamps to about 20 milliamps. In some cases, the one or more line lasers may be configured to operate at around 20 milliamps. In some cases, the one or more line lasers may be configured to operate with an optical power of about 5 milliwatts. In some cases, the one or more line lasers may be configured to generate one or more laser light beams having a wavelength of about 650 nanometers. In some cases, the one or more line lasers may have a laser line aperture angle. The laser line aperture angle may be greater than 62°. In some cases, the one or more line lasers may comprise one or more Class 3R or Class 3B lasers.

In some cases, the one or more laser sources may comprise one or more cross lasers. The one or more cross lasers may be configured to project at least three or more one-dimensional calibration features onto a portion of the material surface. The three or more one-dimensional calibration features may comprise three or more lines or line segments. The three or more lines or line segments may comprise (i) a first line or line segment and (ii) at least two or more parallel lines or line segments. The first line or line segment may comprise a horizontal line when projected onto a substantially flat material surface using a calibrated defect detection system. The at least two or more parallel lines or line segments may comprise two or more vertical lines when projected onto a substantially flat material surface using a calibrated defect detection system. The at least two or more parallel lines or line segments may be perpendicular to the first line or line segment when projected onto a substantially flat material surface using a calibrated defect detection system. The three or more lines or line segments may be configured to intersect at a plurality of intersection points. The plurality of intersection points may correspond to points of intersection between (i) the first line or line segment and (ii) the at least two or more parallel lines or line segments.

In some cases, the one or more cross lasers may be configured to operate at a working voltage that ranges from about 3.3 volts to about 5 volts. In some cases, the one or more cross lasers may be configured to operate at around 3.3 volts. In some cases, the one or more cross lasers may be configured to operate at a load operating current that ranges from about 20 milliamps to about 30 milliamps. In some cases, the one or more cross lasers may be configured to operate at around 30 milliamps. In some cases, the one or more cross lasers may be configured to operate with an optical power of about 5 milliwatts. In some cases, the one or more cross lasers may be configured to generate one or more laser light beams having a wavelength of about 650 nanometers. In some cases, the one or more cross lasers may have a laser line aperture angle. The laser line aperture angle may be greater than 62°. In some cases, the one or more cross lasers may comprise one or more Class 3R or Class 3B lasers.

In some cases, the one or more laser sources may be calibrated before the one or more laser sources are used to project the one or more calibration features. For example, a position and/or an orientation of the one or more line lasers may be adjusted relative to (i) the material surface, (ii) the material fabrication or processing machine, and/or (iii) the one or more cross lasers. In another example, a position and/or an orientation of the one or more cross lasers may be adjusted relative to (i) the material surface, (ii) the material fabrication or processing machine, and/or (iii) the one or more line lasers. The relative position and/or the relative orientation of the one or more cross lasers and/or the one or more line lasers may be adjusted based at least in part on the spatial characteristics of the one or more calibration features projected onto the material surface using the one or more cross lasers and the one or more line lasers.

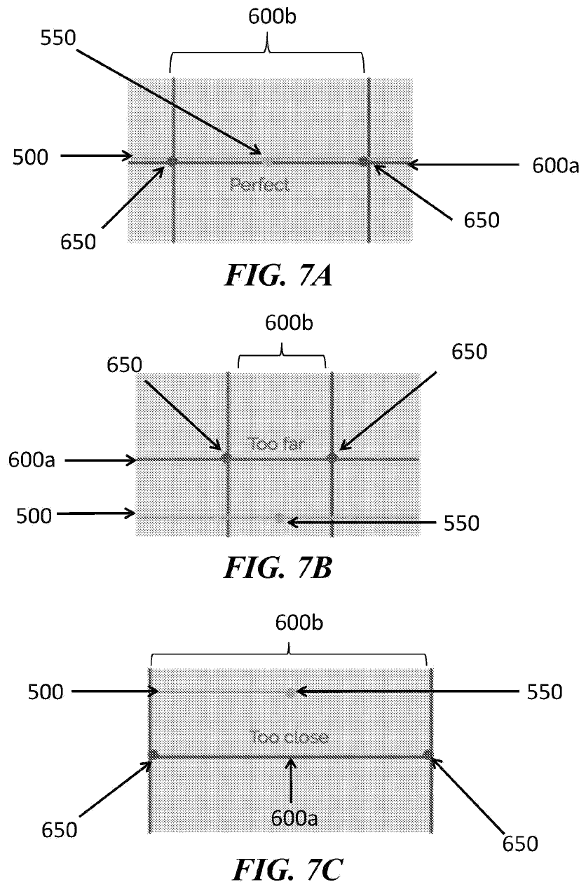

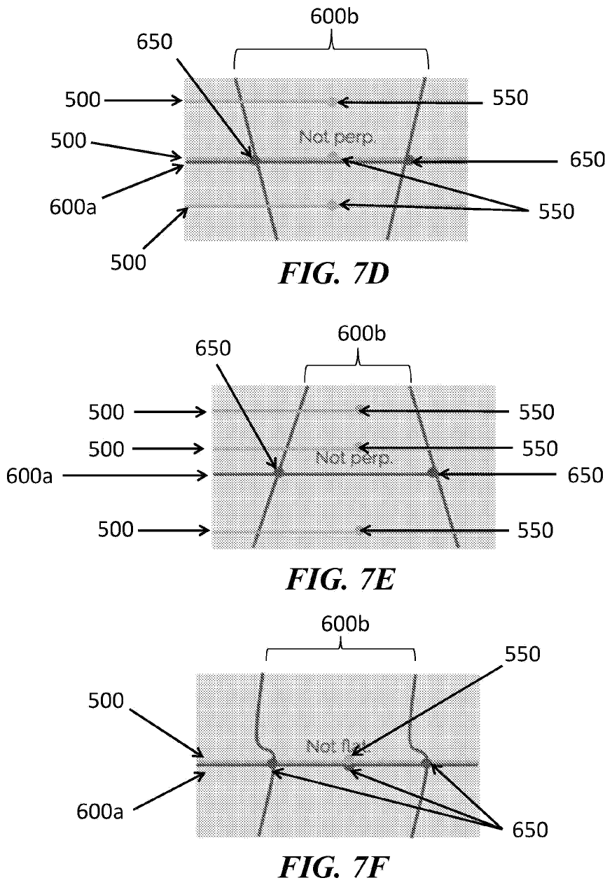

FIGS. 7A, 7B, 7C, 7D, 7E, and 7F illustrate a plurality of calibration features that may be projected onto a material surface using the one or more line lasers and the one or more cross lasers. The plurality of calibration features may comprise a plurality of lines projected using the one or more line lasers and the one or more cross lasers. The one or more line lasers may be configured to project a first set of horizontal lines onto the material surface. The first set of horizontal lines may comprise a first horizontal line 500. In some cases, the first set of horizontal lines may comprise one or more first horizontal lines 500. The one or more first horizontal lines 500 may comprise a first center point 550 corresponding to a center of the one or more first horizontal lines 500. The one or more cross lasers may be configured to project a second set of lines. The second set of lines may comprise a second horizontal line 600a and at least two or more non-horizontal lines 600b that intersect the second horizontal line. The at least two or more non-horizontal lines 600b may intersect the second horizontal line 600a at an angle. The angle may range from 0° to 360°. In some cases, the at least two or more non-horizontal lines 600b may be parallel to each other. In some cases, the at least two or more non-horizontal lines 600b may be perpendicular to the second horizontal line 600a. The at least two or more non-horizontal lines 600b may comprise at least two or more second center points 650 corresponding to a center of the two or more non-horizontal lines 600b. The at least two or more second center points 650 may correspond to points of intersection between the second horizontal line 600a and the at least two or more non-horizontal lines 600b.

FIG. 7A illustrates a scenario in which the first horizontal line 500 generated by the one or more line lasers coincides with the second horizontal line 600a generated by the one or more cross lasers. The first center point 550 and the two or more second center points 650 may lie on the second horizontal line 600a. The first horizontal line 500 projected by the one or more line lasers may be perpendicular to the at least two or more non-horizontal lines 600b projected by the one or more cross lasers. In such a scenario, the defect detection and quality control system may be in a calibrated state. In the calibrated state, the defect detection and quality control system or a component of the defect detection and quality control system (e.g., the defect imaging unit) may be in a position and/or an orientation relative to the material surface or the material fabrication or processing machine such that the defect detection and quality control system is able to determine a quality of a material or detect one or more defects in the material surface with a predetermined level of accuracy and/or a predetermined level of precision.

FIG. 7B illustrates a scenario in which the first horizontal line 500 does not coincide with the second horizontal line 600a. The first horizontal line 500 may be located below the second horizontal line 600a. The first center point 550 and the two or more second center points 650 may not lie on the second horizontal line 600a. In such a scenario, the defect detection and quality control system may not be in a calibrated state (i.e., the defect detection and quality control system may be in an uncalibrated state). In the uncalibrated state, a distance between the defect imaging unit and the material surface may be too far. Alternatively, in the uncalibrated state, a distance between the defect imaging unit and the material fabrication or processing machine may be too far. In some cases, the defect imaging unit may be in an uncalibrated state if the defect imaging unit is provided in a position and/or an orientation relative to the material surface or the material fabrication or processing machine such that the defect detection and quality control system is unable to determine a quality of a material or detect one or more defects in the material surface with a predetermined level of accuracy and/or a predetermined level of precision.

FIG. 7C illustrates a scenario in which the first horizontal line 500 does not coincide with the second horizontal line 600a. The first horizontal line 500 may be located above the second horizontal line 600a. The first center point 550 and the two or more second center points 650 may not lie on the second horizontal line 600a. In such a scenario, the defect detection and quality control system may not be in a calibrated state (i.e., the defect detection and quality control system may be in an uncalibrated state). In the uncalibrated state, a distance between the defect imaging unit and the material surface may be too close. Alternatively, in the uncalibrated state, a distance between the defect imaging unit and the material fabrication or processing machine may be too close. In some cases, the defect imaging unit may be in an uncalibrated state if the defect imaging unit is provided in a position and/or an orientation relative to the material surface or the material fabrication or processing machine such that the defect detection and quality control system is unable to determine a quality of a material or detect one or more defects in the material surface with a predetermined level of accuracy and/or a predetermined level of precision.

FIG. 7D and FIG. 7E illustrate scenarios in which the one or more first horizontal lines 500 projected by the one or more line lasers may not be perpendicular to the at least two or more non-horizontal lines 600b projected by the one or more cross lasers. In such a scenario, the defect detection and quality control system may not be in a calibrated state (i.e., the defect detection and quality control system may be in an uncalibrated state). In the uncalibrated state, the position and/or the orientation of the defect imaging unit relative to the material surface may reduce a level of accuracy and/or a level of precision of the defect detection system. Alternatively, in the uncalibrated state, the position and/or the orientation of the defect imaging unit relative to the material fabrication or processing machine may reduce a level of accuracy and/or a level of precision of the defect detection system. In some cases, the defect imaging unit may be uncalibrated if the defect imaging unit is provided in a position and/or an orientation relative to the material surface or the material fabrication or processing machine such that the defect detection and quality control system is unable to determine a quality of a material or detect one or more defects in the material surface with a predetermined level of accuracy and/or a predetermined level of precision.

FIG. 7F illustrates a scenario in which the at least two or more non-horizontal lines 600b projected by the one or more cross lasers may not appear as straight lines when projected onto the material surface. In such a scenario, the defect detection and quality control system may not be in a calibrated state (i.e., the defect detection and quality control system may be in an uncalibrated state) due to the material surface not being flat or substantially flat. When the material surface is not flat or substantially flat, the material surface may distort the one or more calibration features projected onto the material surface using an otherwise calibrated defect detection and quality control system comprising one or more calibrated components. In some cases, the defect detection and quality control system may be in an uncalibrated state if and/or when a distance and/or a relative orientation between the defect imaging unit and one or more portions of the material surface varies across a dimension (i.e., a length, a width, and/or a height) of the material surface. The varying distance and/or the varying relative orientation between the defect imaging unit and the one or more portions of the material surface may reduce a level of accuracy and/or a level of precision of the defect detection and quality control system when the defect detection and quality control system is used to determine a quality of a material or to detect one or more defects.

In some embodiments, the method may further comprise: (b) determining one or more spatial characteristics of the one or more calibration features based at least in part on the optical projection of the one or more calibration features onto the material surface. As described above, the one or more spatial characteristics may comprise (i) a distance between the one or more calibration features, (ii) relative positions of the one or more calibration features in relation to each other, (iii) relative orientations of the one or more calibration features in relation to each other, (iv) an alignment of the one or more calibration features relative to each other, (v) a size of the one or more calibration features, and/or (vi) a shape of the one or more calibration features.

In some cases, the one or more spatial characteristics may exhibit a degree of parallelism. In other cases, the one or more spatial characteristics may exhibit a degree of perpendicularity. Alternatively, the one or more spatial characteristics may exhibit a degree of collinearity or a degree of straightness. In some cases, the one or more spatial characteristics may exhibit a degree of correspondence relative to a set of reference spatial characteristics. The degree of parallelism, perpendicularity, collinearity, straightness, and/or the degree of correspondence may or may not indicate a need to perform a mechanical calibration for the defect detection and quality control system, based on one or more predetermined or adjustable tolerance levels.

In some cases, the one or more spatial characteristics may be determined based on one or more images of the one or more calibration features projected onto the material surface. The one or more images may be obtained or captured using a calibration analysis unit as described above. The calibration analysis unit may comprise one or more image capture devices (e.g., one or more cameras) configured to capture one or more images of the material surface after the one or more calibration features are projected onto the material surface.

In some cases, the one or more images may be captured using a plurality of image capturing devices. The plurality of image capturing devices may be configured to capture one or more images of at least a portion of the material surface after the one or more calibration features are projected onto the material surface.

In some cases, each of the plurality of image capturing devices may be configured to capture one or more images comprising at least a portion of the one or more calibration features projected by a laser source. For example, a first image capturing device may be configured to capture one or more images comprising at least a portion of the one or more calibration features projected by a first laser source, and a second image capturing device may be configured to capture one or more images comprising at least a portion of the one or more calibration features projected by a second laser source.

The plurality of image capturing devices may be positioned and/or oriented in a predetermined spatial configuration relative to the one or more laser sources used to project the one or more calibration features. The predetermined spatial configuration may enable the plurality of image capturing devices to determine the one or more spatial characteristics associated with the one or more projected calibration features. In some cases, the predetermined spatial configuration may be adjustable. In such cases, the predetermined spatial configuration may be adjusted based at least in part on the one or more images captured by the plurality of image capturing devices.

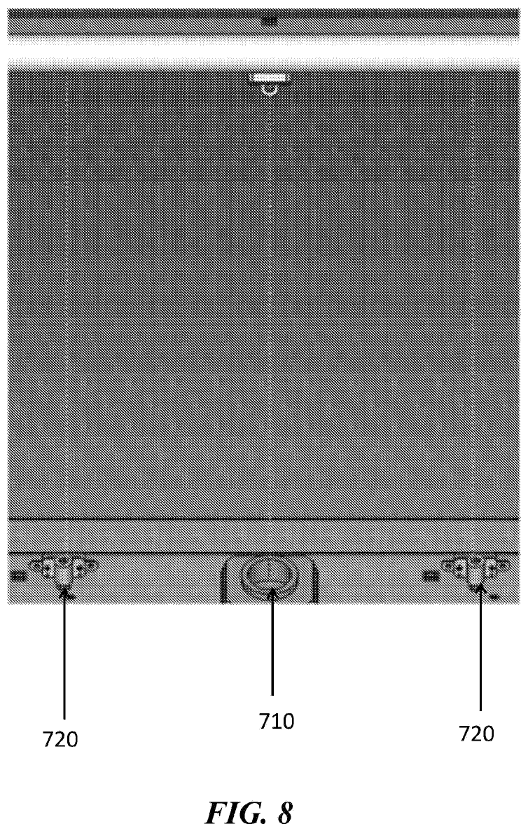

FIG. 8 illustrates an alignment between a camera 710 and one or more laser sources 720 used to project the one or more calibration features onto the material surface. In some cases, the camera 710 and the one or more laser sources 720 may be arranged in a lateral or side-by-side configuration. In such cases, the camera 710 and the one or more laser sources 720 may be positioned at a same distance from the material surface. In other cases, the camera 710 and the one or more laser sources 720 may be arranged in a non-lateral configuration. The non-lateral configuration may comprise a circular or ring configuration wherein the one or more laser sources 720 are arranged around the camera 710. In some cases, the camera 710 and the one or more laser sources 720 may be positioned at different distances from the material surface. In any of the embodiments described herein, at least one camera or image capturing device may be used in conjunction with each of the one or more laser sources to capture one or more images comprising the one or more calibration features projected by each of the one or more laser sources.

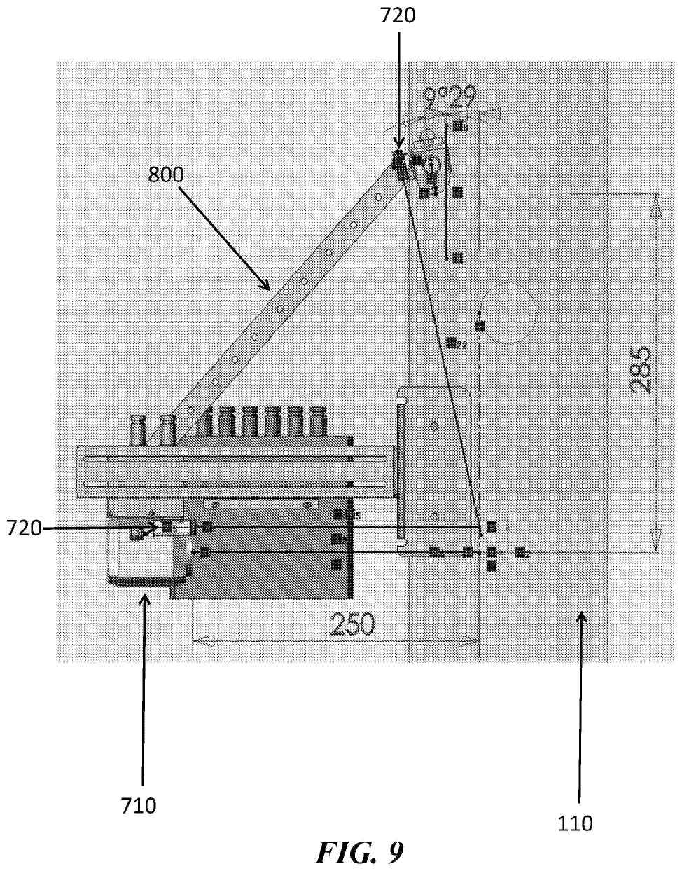

As shown in FIG. 9, in some cases, the defect detection system may comprise an adjustable mechanism 800. The adjustable mechanism 800 may be configured to adjust a position and/or an orientation of one or more cameras 710 and/or one or more laser sources 720 relative to a material surface 110. The adjustable mechanism 800 may comprise an adjustable arm with a plurality of holes. The adjustable arm may be configured to adjust a position and/or an orientation of one or more cameras 710 and/or one or more laser sources 720 relative to a material surface 110. The adjustable arm may be configured to adjust a distance between (i) the one or more cameras 710 and/or one or more laser sources 720 and (ii) the material surface 110. In some cases, the adjustable arm may be configured to adjust a height of a camera 710 and/or a height of a laser source 720 relative to the material surface 110. In some cases, the adjustable arm may be configured to calibrate a position and/or an orientation of the one or more laser sources before the one or more cameras are used to capture one or more images of the material surface with the one or more projected calibration features.

In one non-limiting example, a laser source 720 may be positioned adjacent to an upper portion of the adjustable mechanism 800. In such cases, the laser source 720 may be provided in a substantially horizontal or low angle configuration relative to the material surface. In such cases, the laser source 720 may be configured to provide a low-angle projection of the one or more calibration features onto the material surface. As described above, the adjustable arm may be configured to adjust a position and/or an orientation of the low-angle laser source relative to the material surface. In some cases, the adjustable arm may be configured to adjust a relative position and/or a relative orientation of a camera associated with the low-angle laser source in relation to the material surface and/or the material fabrication or processing machine in which the material surface is provided.

In some embodiments, the method may further comprise using the one or more spatial characteristics to adjust a position and/or an orientation of a defect imaging unit relative to the material surface and the material fabrication or processing machine. In other embodiments, the method may further comprise using the one or more spatial characteristics to adjust an angle or an inclination of the material surface relative to the defect imaging unit. In some embodiments, the method may further comprise using the one or more spatial characteristics to adjust one or more imaging parameters associated with the defect detection and quality control system or a component of the defect detection and quality control system (e.g., a defect imaging device). In some embodiments, the method may further comprise using the one or more spatial characteristics to adjust one or more lighting parameters associated with the defect detection and quality control system or a component of the defect detection and quality control system (e.g., a defect imaging device).

In some cases, the relative position and/or the relative orientation of the defect imaging unit in relation to the material surface and/or the material fabrication or processing machine may be adjusted based at least in part on an alignment between two or more laser lines projected by the laser sources. In some cases, the relative position and/or the relative orientation of the defect imaging unit in relation to the material surface and/or the material fabrication or processing machine may be adjusted based at least in part on a spatial characteristic of the one or more calibration features projected onto the material surface.

The relative position and/or the relative orientation of the defect imaging unit may be adjusted using one or more mechanical components. The one or more mechanical components may comprise structural components such as bearings, axles, splines, fasteners, seals, and/or lubricants. The one or more mechanical components may comprise mechanisms that can control movement, such as gear trains, belt or chain drives, linkages, cam and follower systems, or brakes and clutches. The one or more mechanical components may comprise control components such as buttons, switches, indicators, sensors, actuators and/or computer controllers. In some cases, the one or more mechanical components may comprise shafts, couplings, bearings (e.g., roller bearings, plain bearings, thrust bearings, ball bearings, linear bearings, and/or pillow blocks), fasteners, keys, splines, cotter pins, seals, belts, chains, cable drives, clutches, brakes, gears (e.g., spur gears, helical gears, worm gears, herringbone gears, and/or sprockets), gear trains, cam and follower systems, linkages, wires, and/or cables.

The one or more mechanical components may be configured to adjust the position and/or the orientation of the defect imaging unit in the XY-plane, the XZ-plane, and/or the YZ-plane. The one or more mechanical components may be configured to adjust the position and/or the orientation of the defect imaging unit by translating the defect imaging unit in the X-direction, the Y-direction, and/or the Z-direction. The one or more mechanical components may be configured to adjust the position and/or the orientation of the defect imaging unit by rotating the defect imaging unit about an X-axis, a Y-axis, and/or a Z-axis.

In some cases, the position and/or the orientation of the defect imaging unit may be adjusted based at least in part on a comparison of: (1) an image of the one or more projected calibration features having the one or more spatial characteristics, with (2) a reference image comprising a set of reference calibration features having a set of reference spatial characteristics. The set of reference calibration features may correspond to one or more calibration features projected onto a substantially flat material surface using a calibrated defect detection and quality control system. A calibrated defect detection and quality control system may correspond to a defect detection and quality control system with one or more calibrated components (e.g., a calibrated defect imaging unit). The one or more calibrated components may be in a position and/or an orientation relative to the material surface such that the defect detection and quality control system is able to determine a quality of a material or detect one or more defects at a predetermined level of accuracy or a predetermined level of precision. In some cases, a calibrated defect detection and quality control system may correspond to a defect detection and quality control system with a set of imaging parameters that enable the defect detection and quality control system to determine a quality of a material or detect one or more defects with a predetermined level of accuracy or a predetermined level of precision. In some cases, a calibrated defect detection and quality control system may correspond to a defect detection and quality control system with a set of lighting parameters that enable the defect detection and quality control system to determine a quality of a material or detect one or more defects with a predetermined level of accuracy or a predetermined level of precision. The set of reference spatial characteristics associated with the set of reference calibration features may correspond to one or more spatial characteristics associated with one or more calibration features projected onto a substantially flat material surface using a calibrated defect detection and quality control system. If one or more calibration features are (i) projected onto a material surface that is not substantially flat or (ii) projected using a defect detection and quality control system that is not calibrated, there may be an observable difference between (i) the one or more spatial characteristics associated with the one or more projected calibration features and (ii) the set of reference spatial characteristics associated with the set of reference calibration features. If one or more calibration features are (i) projected onto a material surface that is not substantially flat or (ii) projected using a defect detection and quality control system that is not calibrated, there may be an observable offset between a position, an orientation, a size, and/or a shape of (i) the one or more projected calibration features and (ii) the set of reference calibration features. If the defect detection and quality control system is in an uncalibrated state, there may be an observable difference between (i) the one or more spatial characteristics associated with the one or more projected calibration features and (ii) the set of reference spatial characteristics associated with the set of reference calibration features. If the defect detection and quality control system is in an uncalibrated state, there may be an observable offset between a position, an orientation, a size, and/or a shape of (i) the one or more projected calibration features and (ii) the set of reference calibration features.

In some cases, adjusting the position and/or the orientation of the defect imaging unit may comprise modifying a position and/or an orientation of one or more components of the defect detection and quality control system (e.g., the defect imaging unit) relative to the material surface or the material fabrication or processing machine, based at least in part on the observable offset and/or the observable difference. For example, the position and/or the orientation of the defect imaging unit may be adjusted based on an observable difference between (i) the one or more spatial characteristics associated with the one or more projected calibration features and (ii) the set of reference spatial characteristics associated with the set of reference calibration features. The set of reference calibration features may comprise one or more calibration features projected onto a substantially flat material surface using a calibrated defect detection and quality control system. The observable difference may comprise a difference in size, shape, position, and/or orientation. In another example, the position and/or the orientation of the defect imaging unit may be adjusted based on an observable offset between a position, an orientation, a size, and/or a shape of (i) the one or more projected calibration features and (ii) the set of reference calibration features. The observable offset may comprise a positional offset and/or an angular offset.

In some cases, a position, an orientation, an inclination, and/or a layout of the material surface may be adjusted based on an observable offset between a position, an orientation, a size, and/or a shape of (i) the one or more projected calibration features and (ii) the set of reference calibration features. The observable offset may comprise a positional offset and/or an angular offset. The layout of the material surface may be adjusted by stretching one or more portions of the material surface or by compressing one or more portions of the material surface.

In some cases, one or more imaging parameters associated with the defect detection and quality control system may be adjusted based on an observable offset between a position, an orientation, a size, and/or a shape of (i) the one or more projected calibration features and (ii) the set of reference calibration features. The observable offset may comprise a positional offset and/or an angular offset.

In some cases, one or more lighting parameters associated with the defect detection and quality control system may be adjusted based on an observable offset between a position, an orientation, a size, and/or a shape of (i) the one or more projected calibration features and (ii) the set of reference calibration features. The observable offset may comprise a positional offset and/or an angular offset.

In some embodiments, the position and/or the orientation of the defect imaging unit may be further adjusted based at least in part on a depth map of the material surface. The depth map may comprise information on relative distances between the defect imaging unit and a plurality of points located on the material surface. The depth map may be obtained using a depth sensor. In some cases, the depth sensor may comprise a stereoscopic camera or a time-of-flight camera.

In some embodiments, a calibration algorithm may be implemented to determine (i) if a calibration is needed and/or (ii) an amount of calibration is required. The calibration algorithm may be configured to make such determinations based at least in part on the relative spatial relationships of the one or more calibration features. For example, the calibration algorithm may make such determinations based on a comparison of (i) the relative spatial relationships of the one or more calibration features and (ii) a set of reference spatial characteristics associated with a set of reference calibration features projected onto a substantially flat material surface using a calibrated defect detection and quality control system. A comparison of (i) the relative spatial relationships of the one or more calibration features and (ii) a set of reference spatial characteristics associated with a set of reference calibration features may reveal an observable offset (e.g., a positional offset and/or an angular offset). In some cases, the calibration algorithm may be configured to determine an amount of calibration required based on a comparison of the observable offset and a level of tolerance. The amount of calibration may be sufficient to reduce or eliminate the observable offset. The level of tolerance may comprise a first range of values within which calibration may be required. Alternatively, the level of tolerance may comprise a second range of values within which calibration may not be required. In some cases, the level of tolerance may comprise a first threshold value which may indicate that calibration may be required. Alternatively, the level of tolerance may comprise a second threshold value which may indicate that calibration may not be required.

In some embodiments, the level of tolerance may be predetermined. The level of tolerance may be adjusted by a user or an operator of the one or more laser sources, the material fabrication or processing machine, the defect detection and quality control system, the defect imaging device, and/or the calibration system described in greater detail below. In some cases, the level of tolerance may be adjusted based on the size, shape, or type of material. In some cases, the level of tolerance may be adjusted based on the position or orientation of the imaging device relative to the material fabrication or processing machine. In some cases, the level of tolerance may be adjusted based on the position or orientation of the one or more laser sources relative to the material surface or the material fabrication or processing machine. In some cases, the level of tolerance may be adjusted based on the position or orientation of one or more cameras relative to (i) one or more laser sources, (ii) the material surface, or (iii) the material fabrication or processing machine. In some embodiments, the level of tolerance may depend on an accuracy or reading error associated with the one or more cameras.

In some cases, the position and/or the orientation of the defect imaging device may be adjusted if an observable difference and/or an observable offset is greater than a predetermined threshold value associated with a predetermined tolerance level. In some cases, the position and/or the orientation of the defect imaging device may be adjusted if an observable difference and/or an observable offset is greater than or less than a predetermined range of values associated with a predetermined tolerance level. In some cases, the position, orientation, and/or inclination of the material surface may be adjusted based on a comparison of the observable offset and the level of tolerance. In some cases, one or more imaging parameters associated with the defect detection and quality control system may be adjusted based on a comparison of the observable offset and the level of tolerance. In some cases, one or more lighting parameters associated with the defect detection and quality control system may be adjusted based on a comparison of the observable offset and the level of tolerance.

In any of the embodiments described herein, the detection of defects or substandard quality in a manufactured material or product may lead to one of several outcomes. In some cases, the detection of defects or substandard quality in a manufactured material or product may lead to more than one outcome. The detection of one or more defects or substandard quality in a manufactured material or product may prompt the recalibration of the defect detection and quality control system. The detection of one or more defects or substandard quality in a manufactured material or product may cause the stoppage of a manufacturing process or device. The detection of one or more defects or substandard quality in a manufactured material or product may prompt the repair of a manufacturing device. The detection of one or more defects or substandard quality in a manufactured material or product may prompt the recalibration of a manufacturing device. The detection of one or more defects or substandard quality in a manufactured material or product may prompt the replacement of a feed to a manufacturing process or machine. The detection of one or more defects or substandard quality in a manufactured material or product may lead to a material or product being discarded. The detection of one or more defects or substandard quality in a manufactured material or product may lead to a material or product being repaired. The detection of one or more defects or substandard quality in a manufactured material or product may lead to a material or product being reproduced. The detection of one or more defects or substandard quality in a manufactured material or product may prompt intervention by a human operator of the manufacturing process or device. The detection of one or more defects or substandard quality in a manufactured material or product may prompt intervention by a control system in a manufacturing process or device.

In another aspect, the present disclosures provides a system for performing calibration. The system may comprise a projection unit configured to generate an optical projection of one or more calibration features onto a material surface. In some cases, the material surface may be provided in a material fabrication or processing machine.

In some embodiments, the system may further comprise a calibration analysis unit configured to determine one or more spatial characteristics of the one or more calibration features based at least in part on the optical projection. The one or more spatial characteristics may comprise one or more of the following: (i) a distance, (ii) a position, (iii) an orientation, (iv) an alignment, (v) a size or (vi) a shape of the one or more calibration features. The calibration analysis unit may comprise one or more image capture devices (e.g., one or more cameras). The calibration analysis unit may be configured to obtain and/or capture one or more images of the material surface. The material surface may comprise the one or more calibration features optically projected onto the material surface by the projection unit. In some cases, the calibration analysis unit may be configured to implement an image processing algorithm to process the one or more images of the material surface to determine one or more spatial characteristics of the one or more calibration features based at least in part on the optical projection of the one or more calibration features onto the material surface. In some cases, the calibration analysis unit may be configured to implement an image processing algorithm to process the one or more images of the material surface to determine one or more spatial characteristics of the one or more calibration features based at least in part on the one or more images. In some cases, the calibration analysis unit may be configured to implement a quality control algorithm as described above.

In some embodiments, the system may further comprise a defect imaging unit. The defect imaging unit may comprise any system or device capable of determining a quality of a material or detecting and/or capturing images of material defects or substandard materials or products via the transmission, reflection, refraction, scattering or absorbance of light. A position and/or an orientation of the defect imaging unit relative to the material surface and/or the material fabrication or processing machine may be adjusted based at least in part on the one or more spatial characteristics. In some cases, the one or more images taken by the defect imaging unit may be usable to adjust at least a position or an orientation of a defect imaging unit. In other cases, the one or more images taken by the defect imaging unit may be usable to adjust an angle or an inclination of a material surface relative to the defect imaging unit. Alternatively, the one or more images taken by the defect imaging unit may be usable to adjust one or more imaging parameters associated with the defect imaging unit. In some cases, the one or more images taken by the defect imaging unit may be usable to adjust one or more lighting parameters associated with the defect imaging unit.

In some cases, the calibration analysis unit may be configured to provide feedback to the defect imaging unit based on a comparison of (i) one or more spatial characteristics associated with the one or more optically projected calibration features and (ii) a set of reference spatial characteristics associated with a set of reference calibration features within a reference image. In such cases, the position and/or the orientation of the defect imaging unit may be calibrated in part based on the feedback received from the calibration analysis unit. In some cases, an angle or an inclination of the material surface relative to the defect imaging unit may be adjusted in part based on the feedback received from the calibration analysis unit. In some cases, one or more imaging parameters associated with the defect imaging unit may be adjusted in part based on the feedback received from the calibration unit. In some cases, one or more lighting parameters associated with the defect imaging unit may be adjusted in part based on the feedback received from the calibration unit.

In some cases, calibration may be performed using one or more calibration features that are not optically projected onto a material surface. In some cases, the cameras of the defect detection and quality control systems described herein may be calibrated using one or more images of the material surface, which material surface may comprise one or more calibration features. In some cases, the defect detection and quality control systems may be configured to implement an algorithm to optimize one or more operational parameters of the cameras for an optimal spatial resolution or imaging performance. The algorithm may comprise, for example, an artificial intelligence or machine learning based algorithm. The one or more artificial intelligence or machine learning based algorithms can be used to implement adaptive control of the calibration system (or one or more components or subsystems of the defect detection and quality control system) based on one or more images of the material surface or the one or more calibration features provided on the material surface. The artificial intelligence or machine learning based algorithm may be, for example, an unsupervised learning algorithm, a supervised learning algorithm, or a combination thereof. In some embodiments, the artificial intelligence or machine learning based algorithm may comprise a neural network (e.g., a deep neural network (DNN)). In some embodiments, the deep neural network may comprise a convolutional neural network (CNN). The CNN may be, for example, U-Net, ImageNet, LeNet-5, AlexNet, ZFNet, GoogleNet, VGGNet, ResNet18, or ResNet, etc. In some cases, the neural network may be, for example, a deep feed forward neural network, a recurrent neural network (RNN), LSTM (Long Short Term Memory), GRU (Gated Recurrent Unit), an autoencoder, a variational autoencoder, an adversarial autoencoder, a denoising autoencoder, a sparse autoencoder, a Boltzmann machine (BM), a restricted Boltzmann machine (RBM or Restricted BM), a deep belief network, a generative adversarial network (GAN), a deep residual network, a capsule network, or an attention/transformer networks. In some embodiments, the neural network may comprise one or more neural network layers. In some instances, the neural network may have at least about 2 to 1000 or more neural network layers. In some cases, the artificial intelligence or machine learning based algorithm may be configured to implement, for example, a random forest, a boosted decision tree, a classification tree, a regression tree, a bagging tree, a neural network, or a rotation forest.

Computer Systems.

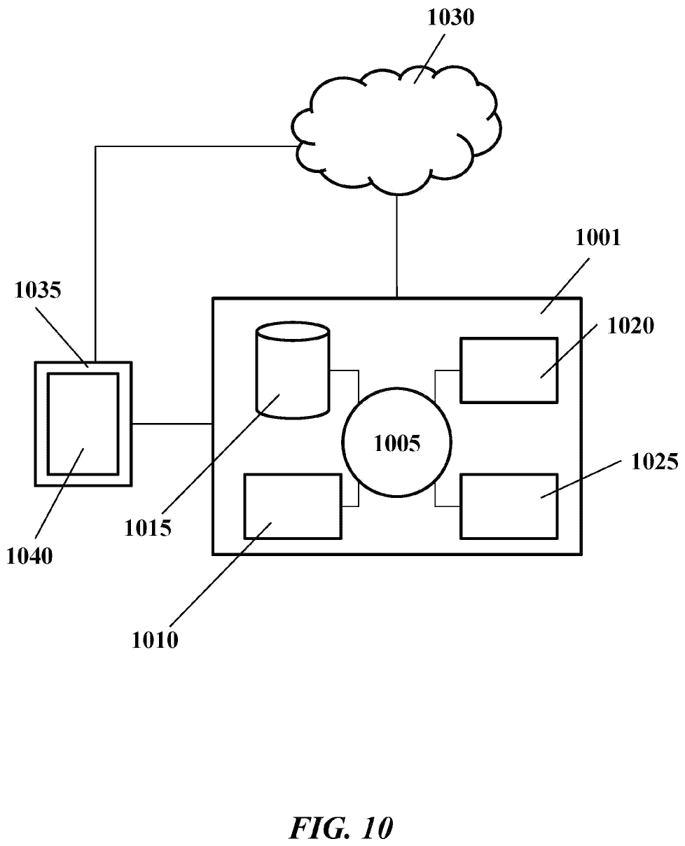

In an aspect, the present disclosure provides computer systems that are programmed or otherwise configured to implement methods of the disclosure. FIG. 10 shows a computer system 1001 that is programmed or otherwise configured to implement a method for mechanical calibration. The computer system 1001 may be configured to, for example, generate an optical projection of one or more calibration features onto a material surface. The material surface may be provided in a material fabrication or processing machine. The computer system 1001 may be configured to determine one or more spatial characteristics of the one or more calibration features based at least in part on the optical projection. The one or more spatial characteristics may comprise a distance, a position, an orientation, an alignment, a size, or a shape of the one or more calibration features. The computer system 1001 may be configured to use the one or more spatial characteristics to adjust at least one of (i) a position or an orientation of an imaging unit relative to the material surface and the material fabrication or processing machine, or (ii) an angle or an inclination of the material surface relative to the imaging unit. The computer system 1001 can be an electronic device of a user or a computer system that is remotely located with respect to the electronic device. The electronic device can be a mobile electronic device.

The computer system 1001 may include a central processing unit (CPU, also “processor” and “computer processor” herein) 1005, which can be a single core or multi core processor, or a plurality of processors for parallel processing. The computer system 1001 also includes memory or memory location 1010 (e.g., random-access memory, read-only memory, flash memory), electronic storage unit 1015 (e.g., hard disk), communication interface 1020 (e.g., network adapter) for communicating with one or more other systems, and peripheral devices 1025, such as cache, other memory, data storage and/or electronic display adapters. The memory 1010, storage unit 1015, interface 1020 and peripheral devices 1025 are in communication with the CPU 1005 through a communication bus (solid lines), such as a motherboard. The storage unit 1015 can be a data storage unit (or data repository) for storing data. The computer system 1001 can be operatively coupled to a computer network (“network”) 1030 with the aid of the communication interface 1020. The network 1030 can be the Internet, an internet and/or extranet, or an intranet and/or extranet that is in communication with the Internet. The network 1030 in some cases is a telecommunication and/or data network. The network 1030 can include one or more computer servers, which can enable distributed computing, such as cloud computing. The network 1030, in some cases with the aid of the computer system 1001, can implement a peer-to-peer network, which may enable devices coupled to the computer system 1001 to behave as a client or a server.

The CPU 1005 can execute a sequence of machine-readable instructions, which can be embodied in a program or software. The instructions may be stored in a memory location, such as the memory 1010. The instructions can be directed to the CPU 1005, which can subsequently program or otherwise configure the CPU 1005 to implement methods of the present disclosure. Examples of operations performed by the CPU 1005 can include fetch, decode, execute, and writeback.

The CPU 1005 can be part of a circuit, such as an integrated circuit. One or more other components of the system 1001 can be included in the circuit. In some cases, the circuit is an application specific integrated circuit (ASIC).

The storage unit 1015 can store files, such as drivers, libraries and saved programs. The storage unit 1015 can store user data, e.g., user preferences and user programs. The computer system 1001 in some cases can include one or more additional data storage units that are located external to the computer system 1001 (e.g., on a remote server that is in communication with the computer system 1001 through an intranet or the Internet).

The computer system 1001 can communicate with one or more remote computer systems through the network 1030. For instance, the computer system 1001 can communicate with a remote computer system of a user (e.g., a user or an operator of a material fabrication or material processing machine, or a user controlling the manufacture of a material or a product). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 1001 via the network 1030.

Methods as described herein can be implemented by way of machine (e.g., computer processor) executable code stored on an electronic storage location of the computer system 1001, such as, for example, on the memory 1010 or electronic storage unit 1015. The machine executable or machine readable code can be provided in the form of software. During use, the code can be executed by the processor 1005. In some cases, the code can be retrieved from the storage unit 1015 and stored on the memory 1010 for ready access by the processor 1005. In some situations, the electronic storage unit 1015 can be precluded, and machine-executable instructions are stored on memory 1010.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 1001, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media including, for example, optical or magnetic disks, or any storage devices in any computer(s) or the like, may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RANI, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1001 can include or be in communication with an electronic display 1035 that comprises a user interface (UI) 1040 for providing, for example, a portal for a user or an operator of a material fabrication or processing machine to control a projection of one or more calibration features onto a material surface. In some cases, the user interface may provide a portal for a user or an operator to mechanically adjust or calibrate a position or an orientation of a defect imaging unit relative to a material surface or a material fabrication or processing machine. The portal may be provided through an application programming interface (API). A user or entity can also interact with various elements in the portal via the UI. Examples of UT's include, without limitation, a graphical user interface (GUI) and web-based user interface.

Methods and systems of the present disclosure can be implemented by way of one or more algorithms. An algorithm can be implemented by way of software upon execution by the central processing unit 1005. The algorithm can, for example, implement a method for mechanical calibration. The method may comprise generating an optical projection of one or more calibration features onto a material surface. The material surface may be provided in a material fabrication or processing machine. The method may comprise determining one or more spatial characteristics of the one or more calibration features based at least in part on the optical projection. The one or more spatial characteristics may comprise a distance, a position, an orientation, an alignment, a size, or a shape of the one or more calibration features. The method may comprise using the one or more spatial characteristics to adjust at least one of (i) a position or an orientation of an imaging unit relative to the material surface and the material fabrication or processing machine, or (ii) an angle or an inclination of the material surface relative to the imaging unit.

### Additional Embodiments

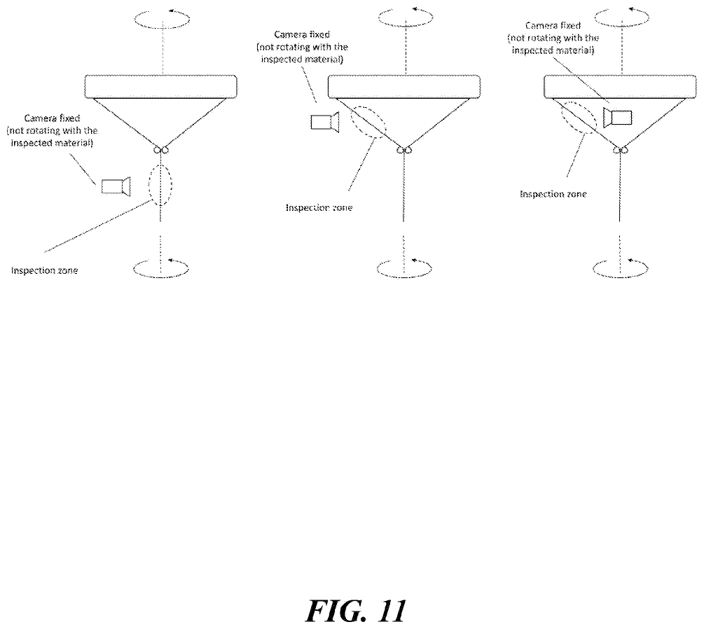

FIG. 11 illustrates an example of an optical detection system for defect detection and quality control. The optical detection system may comprise one or more imaging units with line of sight to one or more inspection zones. The one or more imaging units may be used to detect defects, perform quality control, and/or perform calibration. The one or more inspection zones may correspond to one or more portions or regions of a material fabrication or processing machine (e.g., a circular knitting machine), or one or more portions or regions of a material that is produced using the material fabrication or processing machine. The one or more imaging units may be located remote from the material fabrication or processing machine. The one or more imaging units may be positioned adjacent to the material fabrication or processing machine. In some cases, the one or more imaging units may be affixed, coupled, or attached to a portion (e.g., a structural component) of the material fabrication or processing machine.

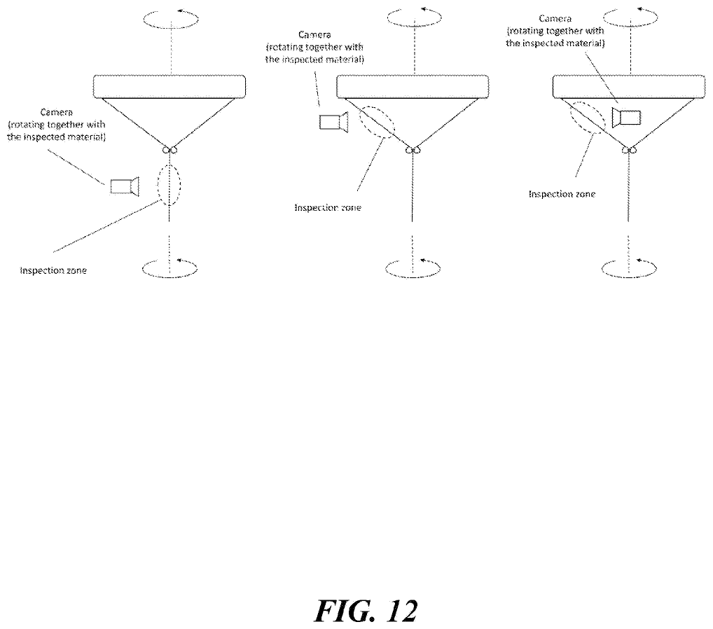

In any of the embodiments described herein, the material fabrication or processing machine may comprise a knitting machine. The knitting machine may comprise, for example, a circular knitting machine. The circular knitting machine may comprise one or more rotatable components. In some cases, at least a portion of the material that is fabricated or processed using the circular knitting machine may rotate relative to the camera. In some embodiments, for example as shown in FIG. 11, the one or more imaging units may be fixed or set in a predetermined position or orientation such that the one or more imaging units do not rotate with the inspected material. In other embodiments, for example as shown in FIG. 12, the one or more imaging units may be configured to move (e.g., rotate and/or translate) relative to the inspected material. In some instances, the one or more imaging units may be configured to rotate together with the inspected material. In some cases, the one or more imaging units may be provided external to or outside of the circular knitting machine. In other cases, the one or more imaging units may be provided inside or within a portion of the circular knitting machine.

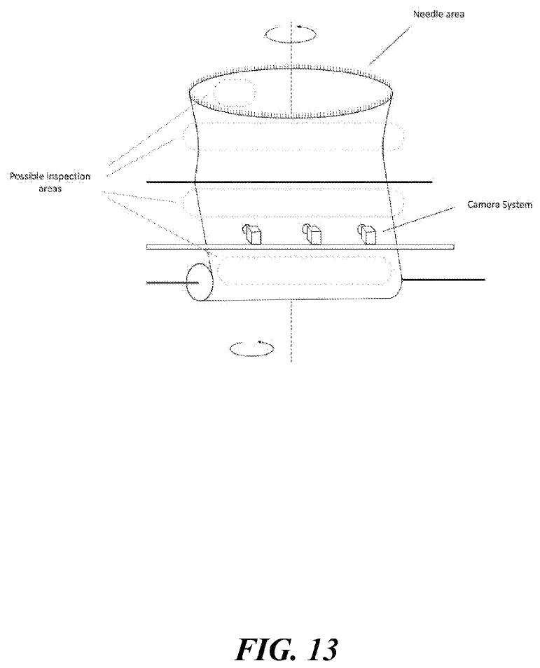

FIG. 13 schematically illustrates various inspection areas that may be monitored using an imaging system. The imaging system may comprise one or more imaging units for detecting defects, performing quality control, and/or calibration. As described above, the one or more imaging units may be fixed and stationary relative to the material fabrication and processing machine or a material that is produced and/or processed using the material fabrication and processing machine. Alternatively, the one or more imaging units may be configured to move (e.g., translate and/or rotate) relative to the material fabrication and processing machine or a material that is produced and/or processed using the material fabrication and processing machine. The various inspection areas may correspond to different portions or regions of a circular knitting machine or different portions or regions of a material that is fabricated or processed using a circular knitting machine. In some cases, the inspection area may correspond to a portion of the material that is adjacent to a needle area of the circular knitting machine. In some cases, the inspection area may correspond to a portion of the material that is below the needle area. In some embodiments, the various inspection areas may correspond to a front portion and/or a back portion of a fabricated material.

In any of the embodiments described herein, calibration may be performed by obtaining one or more images of a material surface and optimizing one or more imaging parameters, based on software processing of the one or more images, to achieve an optimal spatial resolution.

While preferred embodiments of the present disclosure have been shown and described herein, it will be obvious to those skilled in the art that such embodiments are provided by way of example only. It is not intended that the disclosure be limited by the specific examples provided within the specification. While the disclosure has been described with reference to the aforementioned specification, the descriptions and illustrations of the embodiments herein are not meant to be construed in a limiting sense. Numerous variations, changes, and substitutions will now occur to those skilled in the art without departing from the disclosure. Furthermore, it shall be understood that all aspects of the disclosure are not limited to the specific depictions, configurations or relative proportions set forth herein which depend upon a variety of conditions and variables. It should be understood that various alternatives to the embodiments of the disclosure described herein may be employed in practicing the disclosure. It is therefore contemplated that the disclosure shall also cover any such alternatives, modifications, variations or equivalents. It is intended that the following claims define the scope of the disclosure and that methods and structures within the scope of these claims and their equivalents be covered thereby.

What is claimed is:

1.-82. (canceled)

83. A method for calibration, said method comprising:
(a) obtaining one or more images of a material surface that is provided in a material fabrication or processing machine, wherein said material surface comprises one or more calibration features;
(b) determining one or more spatial characteristics of said one or more calibration features based at least in part on said one or more images, wherein said one or more spatial characteristics comprise one or more of the following: (i) a distance between said one or more calibration features, (ii) a position, (iii) an orientation, (iv) an alignment, (v) a size or (vi) a shape of said one or more calibration features; and
(c) using said one or more spatial characteristics to adjust at least one of (i) a position or an orientation of an imaging unit relative to said material surface or relative to said material fabrication or processing machine, (ii) an angle or an inclination of said material surface relative to said imaging unit, and (iii) one or more imaging parameters of said imaging unit, wherein said one or more imaging parameters comprise an exposure time, a shutter speed, an aperture, a film speed, a field of view, an area of focus, a focus distance, a capture rate, or a capture time associated with said imaging unit.

84. The method of claim 83, wherein said one or more calibration features comprise one or more zero-dimensional (0-D) features, wherein said one or more 0-D features comprise one or more dots.

85. The method of claim 83, wherein said one or more calibration features comprise one or more one-dimensional (1-D) features, wherein said one or more 1-D features comprise one or more lines comprising one or more substantially straight or linear lines, substantially non-linear lines, curved lines, solid lines, broken lines, or any combination thereof.

86. The method of claim 85, wherein said one or more lines comprise at least two lines that (i) are parallel to each other, (ii) are at an oblique angle to each other, (iii) intersect with each other, (iv) are perpendicular to each other, or (v) converge at a point.

87. The method of claim 83, wherein said one or more calibration features comprise one or more two-dimensional (2-D) features, wherein said one or more 2-D features comprise circles, ellipses, n-sided polygons, irregular or amorphous shapes, or any combination thereof.

88. The method of claim 83, wherein said one or more calibration features comprise one or more edge markers projected at or near one or more corners or edges of said material surface.

89. The method of claim 83, wherein said one or more calibration features comprise one or more calibration images comprising barcodes or Quick Response (QR) codes.

90. The method of claim 83, wherein (c)(i) comprises adjusting said position or said orientation of said imaging unit based at least in part on (1) a comparison of an image of said one or more calibration features having said one or more spatial characteristics with a reference image comprising a set of reference calibration features having a set of reference spatial characteristics, or (2) a depth map of said material surface.

91. The method of claim 83, wherein (c)(ii) comprises adjusting said angle or said inclination of said material surface based at least in part on (1) a comparison of an image of said one or more calibration features having said one or more spatial characteristics with a reference image comprising a set of reference calibration features having a set of reference spatial characteristics, or (2) a depth map of said material surface.

92. The method of claim 83, wherein (c)(iii) comprises adjusting said one or more imaging parameters based at least in part on (1) a comparison of an image of said one or more calibration features having said one or more spatial characteristics with a reference image comprising a set of reference calibration features having a set of reference spatial characteristics, or (2) a depth map of said material surface.

93. The method of claim 83, further comprising generating said one or more calibration features by optically projecting said calibration features onto said material surface.

94. The method of claim 93, wherein said projecting is performed by using one or more laser sources comprising at least one or more line lasers or one or more cross lasers.

95. The method of claim 94, wherein (c)(i) comprises adjusting said position or said orientation of said imaging unit based at least in part on an alignment between two or more laser lines projected by said one or more laser sources.

96. The method of claim 94, wherein (c)(ii) comprises adjusting said angle or said inclination of said material surface based at least in part on an alignment between two or more laser lines projected by said one or more laser sources.

97. The method of claim 94, wherein (c)(iii) comprises adjusting said one or more imaging parameters based at least in part on an alignment between two or more laser lines projected by said one or more laser sources.

98. The method of claim 83, further comprising: using said imaging unit to determine at least a type, a shape, or a size of one or more defects within or on said material surface located on a roll-to-roll produced or processed material sheet.

99. The method of claim 83, wherein said material fabrication machine comprises a circular knitting machine or a weaving machine.

100. The method of claim 99, further comprising obtaining said one or more images using one or more cameras positioned inside the circular knitting machine.

101. The method of claim 100, wherein said one or more cameras are positioned inside a tubular portion of said circular knitting machine.

102. The method of claim 83, wherein said one or more calibration features comprise one or more intentionally created defects, patterns, or features.

103. The method of claim 102, wherein said one or more intentionally created defects, patterns, or features are generated by adding or removing one or more strings, threads, or yarns to or from said material surface during a manufacturing or a processing of said material surface.

104. The method of claim 83, wherein said one or more calibration features comprise one or more calibration tools or calibration devices that are not optically projected onto said material surface.

105. The method of claim 104, wherein said one or more calibration tools or calibration devices comprise a sticker, a barcode, a Quick Response (QR) code, or an image that is affixed or attached to said material surface.

106. The method of claim 83, further comprising detecting one or more defects in said material surface based on said one or more images.

107. The method of claim 83, further comprising determining or monitoring a quality of said material surface based on said one or more images.
